(19) United States
(12) Patent Application Publication
(10) Pub. No.: US 2016/0366449 A1
(43) Pub. Date: Dec. 15, 2016

(54) HIGH DEFINITION AND HIGH DYNAMIC RANGE CAPABLE VIDEO DECODER

(71) Applicant: KONINKLIJKE PHILIPS N.V., Eindhoven (NL)

(72) Inventors: Jeroen Hubert Christoffel Jacobus STESSEN, Eindhoven (NL); Renatus Josephus VAN DER VLEUTEN, Veldhoven (NL); Johannes Gerardus Rijk VAN MOURIK, Eindhoven (NL); Rutger NIJLAND, Someren-Eind (NL)

(73) Assignee: KONINKLIJKE PHILIPS N.V., Eindhoven (NL)

(21) Appl. No.: 15/119,000

(22) PCT Filed: Feb. 21, 2015
(86) PCT No.: PCT/EP2015/053669

§ 371 Date: Aug. 15, 2016

Related U.S. Application Data
(60) Provisional application No. 62/022,298, filed on Jul. 9, 2014.

(30) Foreign Application Priority Data
Feb. 21, 2014 (EP) 14156211.6

(51) Int. Cl. H04N 19/98; H04N 19/85; H04N 9/77; H04N 9/67; H04N 1/64

(52) U.S. Cl. CPC H04N 19/98; H04N 9/67; H04N 1/646; H04N 9/77; H04N 19/85

(57) ABSTRACT

Because we needed a new improved and very different color encoding space for being able to faithfully encode the presently emerging high dynamic range video for good quality rendering on emerging HDR displays such as the SIM2 display, we present around that new color space various new decoders which allow simplified processing, in particular the handling of all achromatic direction (i.e. luminance) optimization separate from the chromatic processing, and increased quality of the reconstructed HDR images. This is realized by a video decoder (350) having an input (358) for receiving a video signal (S_im) transmitted over a video transmission system or received on a video storage product, in which pixel colors are encoded with an achromatic luma (Y′) coordinate and two chromaticity coordinates (u″,v″), the video decoder comprising a scaling unit (356) arranged to transform the chromaticity colors into a luminance-dependent chrominance color representation, by scaling with the achromatic luma.

### FIELD OF THE INVENTION

The invention relates to methods and apparatuses for decoding video (i.e. sets of still images), for the future requirements that both high definition (high sharpness) and high dynamic range (high and low brightnesses) should potentially be handled. In particular the decoder work based on a new color space definition.

### BACKGROUND OF THE INVENTION

Ever since the 19th century, additive color reproductions have been represented in an RGB space of driving coordinates for generating red, green and blue primary light outputs. Because giving these different primaries different strengths (linear luminances) is the way to make all colors within the so-called gamut (the diamond shape obtained by the three vectors defined by the maximum driving possible e.g. Rmax, which may for the code R′max of e.g. 255 be e.g. 30 nit rendered on display), which corresponds with particular display or codec RGB primaries in some generic color space like XYZ. Or similarly one can define such colors in another linear space derived from the primaries (e.g. XYZ, or UVW). This is done by linear combination of the vectors, i.e. one can calculate the new color coordinates by multiplying the old ones in the other color space definition by multiplying with a conversion matrix.

Apart from having a good colorimetrical definition of any colors in a scene, and in particular one which immediate models the color generating display (RGB), a second interesting question is how to develop color definitions or spaces which are pragmatic according to some envisaged use, in particular the transmission of color images from a content production to a content consumption side (e.g. a TV or computer etc.), and the handling of these colors (such as complexity of the hardware needed for doing the calculations, etc.). Now it is useful, and was historically necessary for black-and-white television, to have an achromatic direction which only encodes the luminances Y, since also the visual system has a separate processing channel for this (and in addition it has a lower resolution color path). This is obtained by putting the gamut on its tip, which is black, represented in FIG. 1a by the black dot. The gamut of a color representation space, when tied to a reference monitor (or any monitor the signal is sent to if the reference is undefined) is gamut 101. In this same philosophy one could also imagine theoretical primaries which can become infinitely bright, leading to a cone shape 102. Several color spaces are defined according to this principle, especially the closed ones which shrink again on the top side to a white, since they are also useful e.g. for painting, where one must mix pure colors with whites and blacks, and can go no higher than paper white (e.g. Munsell color tree, NCS and Coloroid are examples of such a (bi)conal color space, and CIELUV and CIELAB are open cones).

In the television world and video encoding thereof, a specific set of color spaces around this philosophy emerged. Because CRTs had a gamma which amounted to the outputted luminance being approximately the square of the input driving voltage (and the same for the separate color channels, as actually the non-linearity originally came from the electron gun physics), it was decided to precompensate for this and send signals to the television receivers which were defined as approximately square roots of the linear camera signals (the coded signal quantities being denoted with the dash, e.g. R′ being the square root of R, R being the amount of red in the scene as captured by a camera, and within a range of e.g. [0.0.7 Volt]). Now because one needed to build on top of the existing black and white transmission system (NTSC or PAL), one also made use of this philosophy of using an achromatic (“black-and-white”) coordinate, and two color-information carrying signals R-Y, B-Y (from which G-Y could then be derived). Although the color information signals should ideally convey only chromatic information, due to the approximate combination of non-linear quantities they also carry luminance information, which should not be a problem in there if all mathematical equations are reversed again, but may be a problem in practice. Note also that such signals like R-Y grow linearly (or non-linearly in case of R′-Y′, but they still grow with Y′) with the luminance, which is why one denotes them with the compound wording chrominances. Y in a linear system would be calculable as a*R+b*G+c*B, in which a,b and c are constants dependent on the exact color location of the primaries (or in fact their spectral light emission shape).

However, one did these simple matrixing calculations to obtain the achromatic component in the non-linear space of the derived coordinates R′, G′, B′ (i.e. the square rooted signals). Although the diamond shape (i.e. the outer boundaries) of the gamut doesn't change by such a mathematical operation, the position/definition of all colors within it does (they are displaced by compressing and stretching by a non-linear function). This means inter alia that Y′=a*R′+b*G′+c*B′ is no longer a real luminance signal conveying the exact luminance of all colors, which is why it is called a luma (in general one can call luma any non-linear encoding of linear luminance, or even any linear encoding of luminance).

This was all there was (on bird eye level for placing the embodiments of this invention in the context of prior art) until recently, and it formed the basis of several video coding standards, like the ones of MPEG, which we will call LDR standards, since they were good at coding luminances in a range which is similar to the reflectances we can get from objects, such as inks printed on paper, which must typically fall at around 100% to 0.5%, and perhaps some displays which can create a little brighter and darker pixel colors.

Recently however a desire emerged to start encoding so-called high dynamic range (HDR) video material. These are video images encoded to be rendered preferably on displays with increased luminance contrast capabilities compared to legacy displays (e.g. a 1-100 nit CRT TV, or a 0.1-500 nit LCD TV), typically with a peak white of at least 1000 nit, and often with darker blacks also. Because real world scenes contain far more contrasting average luminance regions (e.g. in bright illumination and deep shadow, or even the very high luminances of the light sources appearing themselves in the image), the coded images to be useful for rendering all this scene detail on high quality displays should also contain all this information with sufficiently high precision. E.g. a scene which contains both indoors and sunny outdoors objects may have an intra-picture luminance contrast ratio of above 1000:1 and up to 10,000, since black may typically reflect 5% and even 0.5% of fully reflecting white, and depending on indoors geometry (e.g. a long corridor largely shielded from the outdoors illumination and hence only indirectly illuminated) indoors illuminance is typically k* 1/100th of outdoors illuminance.

Research into this led us to the understanding that several long since given facts in colorimetry for video had to be re-thought and redefined for HDR (and maybe even renamed when good nomenclature doesn't exist). In particular, the function relating the luminances of objects in the world, or a color component of their color such as red, to luma codes no longer needed nor even could be a square root, but had to be another function, depending perhaps on the specifics of the kinds of scene we would want to code, and technical limitations of the rendering hardware, etc. Therefore we will in this text use the word luma for all calculated (brightness determining) signals along the achromatic axis irrespective of what mapping function is used for mapping luminances to lumas and we will then see Y′ as a technical encoding representing a physical luminance Y of a color. This means that we could even use the luminance itself as a signal encoding of itself, and will assume this as covered when we say luma, to avoid tedious linguistic formulation of our embodiments (even if we use Y to denote the special situation of luma Y′ being chosen a luminance in that embodiment, this should be clearer and cumbersome dual formulations).

Any non-linear definition of the color components in addition to a simplistic linear derivation of them leads however to a so-called constant luminance problem, since some luminance information is not in the Y′ but rather in the chromatic coordinates Cr, Cb.

These are defined as Cr=m*(R′-Y′) and Cb=n*(B′-Y′), and in this text we will call them chrominances because they grow larger with increasing luminance of a color (the term chroma also being used by some). So these coordinates do have some chromatic aspect to them, but also this is mixed with a brightness aspect (psychovisually this is not per se bad because colorfulness is also an appearance factor which grows with brightness). The problem would not be so bad if one did exactly the same inverse decoding, but any transformation on the colors encoded in such a system (which also forms the basis of current MPEG standards) creates problems like e.g. luminance and color errors. In particular this occurs e.g. when one subsamples the chrominances to a lower resolution, in which case any information gone, is just gone (and cannot simply be estimated back). The problem aggravates with the more highly non-linear luminance-to-luma mappings or opto-electrical transfer functions OETF needed for HDR (n.b. actually we think it is advantageous to start a color definition system from its inverse, a reference EOTF). But even for LDR video encoding YCrCb is not the best possible color space to represent colors according to all requirements, but it was a pragmatic one that we could live with.

Another problem is that especially for linear systems, but even for the chromaticities in non-linear color encodings, the coordinates can grow quite large if e.g. Rmax is large, requiring many bits for encoding or the processing ICs. Or in other words, chrominance spaces need many bits to be able to still have enough precision for the very small chrominance values, as with HDR signals, although that can be partially mitigated by defining strong non-linear luma curves defining R′ from R etc.

A second type of color space topologies (FIG. 1b) existed in theoretical colorimetry, of which there are fewer variants though. If we project the linear colors to a unit plane 105 (or 602 in FIG. 6), we get perspective transformations of the type x=X/(X+Y+Z) and y=Y/(X+Y+Z) (and the same for e.g. CIELUV: u=U/(U+V+W) etc.). Since then z=1-x-y, we need only two such chromaticity coordinates. The advantage of such a space is that it transforms the cone into a finite-width cylinder. I.e., one can associate a single chromaticity (x,y) or (u,v) with an object of a particular spectral reflection curve illuminated by some light, and this value is then independent of the luminance Y, i.e. it defines the color of an object irrespective of how much light falls on it. The brightening due to illumination with more light of the same spectral characteristics is just a shifting of the color upwards parallel to the achromatic axis of the cylinder. Such a chromaticity is then for easier human understanding commonly described with the quantities dominant wavelength and purity, or the more human psychovisual quantities hue and saturation. The maximum saturation for any possible hue is obtained by the monochromatic colors forming the horseshoe boundary 103, and the maximum saturation for each hue of a particular additive display (or color space) is determined by the RGB triangle. In fact, the 3D view is needed, because the gamut 104 of an additive reproduction or color space is tent-shaped, with peak white W being the condition in which all colors channels (i.e. the local pixels in a RGB local display subpixel triplet) are maximally driven.

Now our research has led us to—as described below—consider additional color quantities, which nobody would normally use in such technologies, and don't even have a recognized technical name (so we need to define some nomenclature here to be able to concisely describe the below teaching of our embodiments). One could also generically call them some variant of chromaticities, but where confusion could emerge we will name them luma-scaled chromatic coordinates (as said luma potentially being luminance in a particular technical encoding also), or one can also see and call them luma-independent chromatic coordinates, or dynamic-range independent chromatic coordinates, which is important for systems which need to be able to handle at least one high dynamic range of pixel luminances, especially when also other dynamic ranges need to be handled, e.g. when converting a HDR grading to a LDR grading (although there is a sharp difference in look as determined by luma mapping functions, these can be represented by having both gradings in the same relative numerical representation). As seen in FIG. 6, they have similar properties to chromaticities, and are also bounded, but not in the [0.1] interval, but e.g. for practical systems in [0.75] intervals. Actually we can design an e.g. 12 bit code definition for them, the details not relevant for explaining this invention. They are luma-scaled because they are divided by luma Y′ (or Y), e.g. the non-linear red component (with whatever OETF) is scaled to yield R′/Y′, or the CIE X coordinate is scaled to become X/Y etc. This corresponds to a projection not to the [1.1.1] diagonal color plane 602, but to a color plane which goes through Y=1. In other words, we can specify a color vector of color C=(X_C, Y_C, Z-C) with new coordinates X_C/Y-C, Y_C/Y-C, and Z_C/Y-C. Because the second component is always 1, one can understand that only two coordinates are actually necessary to traverse color plane 601, but one can specify redundant triplet color definitions like (R/Y,G/Y,B/Y) too.

The scaling, or perspective transformation, is now not through the origin to plane 602, but to plane 601. Nonetheless, the same mathematical principles apply, and one can see the scaled xx coordinate as a multiplication of X_C by 1/Y_C, or in other words xx/1=X_C/Y_C. So the original 3D color vector can be obtained by multiplying with the luma Y′ again.

A very important property we will use below is that these luma-scaled coordinates are now luma or luminance-independent. This is very important when we want to go to all kinds of HDR technology with variable luminance characteristics, and these insights allowed us to build new technological systems (which were also needed, because LDR technology was not simply mappable to HDR technology). So they exist in some “chromatic-only” dimension. Indeed, as one can see the position of the color coordinate cc of a color C in the plane 601 doesn't change by lengthening the vector C which makes that color brighter. Although the actual location in the color plane 601 still depends on the luminance value Y, it only depends on the ratio of X/Y, so the spectrum-based proportion obtained by weighing with the XYZ sensitivity functions, which is a purely chromatic characterization just like the well-known and normally used (x,y) chromaticities. So color transformations, like e.g. re-codification in a new primary coordinate system can also be done in the 601 plane, since all primaries like e.g. Rmax have their equivalent projection (rr) in plane 601.

For simplicity we have only drawn the case for luminances Y, but during our research we have realized that mutatis mutandis we could also specify the colors with luma-scaled chromatic coordinates by using some differently defined luma function along the achromatic axis (Y-axis), like e.g. a loggamma function. This means projecting to some other Y′=1 plane, but as long as we know how to project out again to colors C the principles stay similar. We could also call these color representations unitary representations because the color plane goes through Y=1, but will use the more suitable naming luma-scaled. As we see in the actual embodiment details below, this is very powerful for designing highly useful new color handling systems.

Historically for good reasons television engineers have never considered, or explicitly rejected, the cylinder-space representations as not very useful for them. Furthermore, the chrominance-based color spaces, for television/video being descendants of e.g. NTSC, or BT. 709, e.g. the Y′CrCb of the various MPEG and other digital compression standards, have been sufficiently good in practice, although there were several known issues, in particular the mixing of the various color channels due to the inappropriate non-linearities (e.g. luminance changes if some operation is done on a color component, or hue changes when one only wanted to change saturation (or better chroma), etc.). The chromaticity-based color spaces, like Yxy or Lu′v′, have never been used or credibly contemplated and developed for image transmission, only for scientific image analysis.

Recently however because of that need to code high dynamic range (HDR) video material, experimentation and contemplation didn't just lead to new problems and insights on the technical principles, but even led the Philips researchers to start thinking of the principles in a non-usual way, and even contemplating a priori strange (a priori assumed unsuitable) ways to approach the principles.

We need to mention one further line of prior research to ultimately enable rendering images wherein the sun really seems to cast its rays on the outdoor objects, or lamps really seem to glow, which involves first better camera capturing, then better handling of the intermediate technologies such as optimal color grading and encoding for storage or transmission, and then finally better display rendering. For still pictures codecs were developed which encode the linear color coordinates (e.g. just a large bit word encoding with high precision the XYZ coordinates of the scene colors), but where this can be done for a single still, for video the speed and several hardware considerations (e.g. the cost of a processing IC, or the space on a BD disk) don't allow or at least dissuade from using such encodings. I.e. from a practical point of view the industry needed different codecs for HDR video.

Now having researched on novel HDR encoding (and decoding) strategies, in this application we focus on new requirements and solutions for handling inter alia the sharpness aspect, and come to optimal image processing chains. Conversion to and fro RGB, XYZ, and some luminance-chromatic color representation like e.g. Yuv may all be fine when done in full resolution, and without further processing like e.g. DCT conversion and quantization of DCT coefficients, in practice we would like typical embodiments of our invention to encode the data (as in a container) in legacy MPEG-like coding structures. These apply subsampling to the color components, i.e. whichever smart optimally defined signal we put in those components, in IC topologies not far modified from legacy encoders these components will get subsampled (e.g. to 4:2:0), and hence we must come with technologies that take this into account and work optimally under these situations, in particular give good sharpness, and few luminance artefacts due to crosstalk between the achromatic luminance and chromatic information.

G. W. Larson “Log Luv Encoding for Full-gamut, High dynamic range images”, Journal of Graphics Tools, association for computing machinery, vol. 3, no. 1, 22 Jan. 1999, pp. 15-31 introduces the concept of encoding for HDR still images, such as e.g. from computer generation, or from photo scans. The use a pure logarithmic mapping to determine a luma from luminance, which would allow encoding of 38 orders of magnitude of luminance, although that is somewhat overkill for practical display systems, which would typically work between approximately 0.001 nit and 10000 nit (i.e. the pure log function is not the most optimal function, inter alia it may show banding on critical parts of images, in particular if the data has to be encoded with few bits, like 8 or 10 bits for the luma L channel). They encode the chromatic information by using CIE 1976 uv coordinates. They encode this data in the TIFF format, with run length compression on sets of adjacent pixel lumas. They also take into account that a common luma scale factor can be taken out of the three for display gamma power function transformed R′,G′,B′ coordinates, hence one can work in a space of normalized R′G′B′coordinates, which can be determined from the u,v coordinates by three first lookup tables, and scale to luminance-dependent R′G′B′driving values (Rd,Gd,Bd), by applying a common scaling factor in the display gamma representation. Any desired tone mapping function can then be implemented in a fourth lookup table Lt(Le). However, although this teaches required mapping in full resolution Luv vs. RGB or XYZ spaces, nothing is taught about what needs to be done if one wants to downsample in such a way that the impact on sharpness and non-linear color component crosstalk is minimized.

R. Mantiuk et al: “Perception-motivated high dynamic range video encoding”, ACM transactions on graphics, vol. 23, no. 3, 1 Aug. 2004, pp. 733-744 teaches another HDR coding technology, also suitable for HDR video encoding. The introduce another log-like curve to define their lumas which encode luminances, and also use uv as chromaticity coordinates. They encode all this in a standard MPEG-4 encoding topology, and teach how the quantization can be optimized for HDR. Although this YCrCb-inspired coding uses 2× spatial subsampling on the color components, Mantiuk doesn't teach any specifics on how one should optimally do the downsampling and up sampling, if one wants to get the best visual quality, for a particular HDR encoding technology, in particular its log-like luma defining code allocation function.

US2013/0156311 (Choi) deals with the problem of color crosstalk for classical PAL-like (incorporated in MPEG encoding) YCrCb color definitions, but only for LDR.

These have a luma Y′ which is calculated with the linear primary weights for a certain white point, but applied on the non-linear R′,G′,B′ values. Then a yellow-bluish component is calculated as a properly scaled B′-Y′, and a greenish-reddish contribution to the color as R′-Y′. Because all coordinates are calculated in the nonlinear gamma 2.2 representation rather than the linear one, some of the luminance information leaks (crosstalks) into the color components. This would not be a problem if ideal reconstruction is inversely done, but there can be problems if some information is lost due to e.g. subsampling of the chrominance coefficients, which then corresponds to throwing away some of the high frequency luminance information too. This can lead to loss of sharpness, but also to color errors on zebra-stripe type of patterns, or similar high frequency image content.

In LDR video coding this was typically not seen as a major problem, and one of the solutions to the worst problems in PAL was that the producers asked the actors to bring non-striped clothes. However, with the arbitrary and strong non-linear functions of HDR, it can be researched that the problem can at times become severely aggravated. It is also not prima facie clear what to do. Choi presents for the LDR scenario a couple of alternative YCrCb encodings. Under the technical constraints of his system, he finds the most problems for strong red, magenta or purple colors. If he detects these, he can derive other encodings, from the linear XYZ space, which components are better decorrelated and lead to less crosstalk issues. E.g. he proposes another Crg channel, which is now not the classical R′-Y′, but instead G′-Y′. In certain situations this may be used as a better alternative, although it leads to a non-standard encoder which needs appropriate flagging to indicate which definition is used. He also proposed to apply the same classical 2.2 gamma on X,Y,Z coefficients, define non-linear X′Y′Z′ based chrominances, and put those in the chromatic color components of an YCrCb encoder. But also here nothing is taught specifically on how exactly, or in which topological order one would need to do the chromatic subsampling.

WO2010/104624 is yet another Luv HDR encoding system, with yet another definition of the logarithmic luma, and no specific teachings on the subsampling.

Since everything seriously changes when moving to the new HDR image encoding, and although it would think less seriously even more so when one wants to additionally obey the constraint that everything can be put in legacy “LDR” MPEG containers after one has redefined the required codec colorimetry, one continuously discovers new aspects and issues about the coding, which then need studying, and further invention and optimization for. In particular, it is not trivial which teachings from legacy LDR subsampling should be used under the now severe non-linearities, and this has to be carefully studied, and optimized, in particular if one wants to achieve the promised high resolution which comes with quad resolution or UHD. One can easily define 4× more pixels, but these should also always be filled with the appropriate pixel values—whatever similar to classical operation is done in the new system—so that one doesn't accidentally create unreasonably blurred images in these sharp containers, because then one still doesn't have a significantly better system than HD in actual practice. To achieve this we invented and present below the following embodiments.

### SUMMARY OF THE INVENTION

Given the more complex constraints we have in HDR encoding, the prior art YCbCr color spaces as described above are not optimal anymore even with some modification, in particular behavior for the darker parts of the image (in HDR a popular scene being e.g. a dark basement with bright lights, but in any case there will be statistically a larger amount of significant pixels in a lower part of a luminance range than for LDR—classical low dynamic range-images) is not optimal. Also, since for HDR we want to have liberal control over the luma code allocation functions (which define the mapping of captured or graded luminances Y to a code Y′ representing them depending on what one needs or desires per situation, see e.g. WO2012/147022), the more severely non-linear nature of the OETF or EOTF compared to the square root of Y′CrCb, would make the erroneous behavior of the typical television encoding luma-chrominance spaces like the exemplary one of FIG. 1a behave highly inappropriate. In particular this would occur when spatially subsampling the color signals from 4:4:4 to 4:2:0, but also for many other reasons which have to do with changing a color coordinate. Many researchers have focused on finding the optimal colorimetric transformations, i.e. whether to define a good luma code allocation function which uses codes as efficient as possible, e.g. because it mimics the response of the human visual system along the high dynamic range of to be coded luminances, or on the tone mappings required to simulate the HDR look in the limited dynamic range capacity of an LDR display or photo print, yet lilttle has been researched on the practical tedious details to optimize the HDR chain not for still photos but the typical particulars of television/video handling systems, in particular the new issues with subsampling of chromatic components as they were chosen long ago because of the then mapped particulars of the human visual systems to the television display requirements of the 1950s, and the determination of a good image processing topology to yield quality results.

When we talk about HDR encoding, the skilled reader should understand that these proposed embodiments can of course also encode LDR images, e.g. encompassed in a HDR encoding, derivable from a HDR image grading etc., but the systems should be so technically modified compared to legacy systems they can also handle the most nasty practical HDR images, with a really high dynamic range (e.g. original scenes with objects of 20000 nit or above, may be converted to a practical artistic master luminance range with e.g. a maximum luminance of say 5000 or 10000 nit by grading the brightest objects into that range, and then be actually encoded with a codec having a corresponding luminance range with a maximum of e.g. 1000 nit, and a corresponding optimized code allocation function to determine lumas from the luminances), critically graded object colors all along the luma range, preferably low banding (and even preferably low complexity of circuits, and bit allocation and fast computation), etc.

Our below described embodiments solve most of the issues of television encoding (or processing) especially for HDR video whether for consumer communication like over DVB broadcasts, or professional video communication like transmission to cinema theaters, in particular by means of a high dynamic range video decoder (350) having an input (358) for receiving a video signal (S_im) of images transmitted over a video transmission system or received on a video storage product, in which pixel colors are encoded with an achromatic luma (Y′) coordinate and two chromaticity coordinates (u″,v″), the video decoder comprising in processing order: first a spatial upsampling unit (913), arranged to increase the resolution of the image components with the chromaticity coordinates (u″,v″), secondly a color transformation unit (909) arranged to transform for the pixels of the increased resolution chromaticity component images the chromaticity coordinates into three luminance-independent red, green and blue color components, which are defined so that the maximum possible luma of such a color is 1.0, and thirdly a luminance scaling unit (930) arranged to transform the three luminance-independent red, green and blue color components into a luminance-dependent red, green and blue color representation, by scaling with a common luma factor calculated on the basis of the achromatic luma (Y′) coordinate.

The upsampling is best done in the chromaticity representation, which is still the most neutral and dynamic range dependent. It can however be done in several variants of useful chromaticity definitions, with corresponding optimal processing topologies.

The skilled person would understand what high dynamic range video means, i.e. it codifies object luminances of at least 1000 nit, as contrasted to legacy LDR video which was graded for maximum (white) object brightnesses of 100 nit. It should also be clear to the skilled person that we can scale with whichever (achromatic) luma we find desirable in the topology. E.g., if we only need to go from an encoded luma-independent chromaticity to a device-independent space like XYZ, the achromatic luma can be the one that scales to this. Or if we need to go directly to display driving coordinates, we can e.g. assume a neutral scene look grading, and then the achromatic luma ultimately used will be the one composed of both the for the input image chosen code allocation strategy, and the one for the display (which may be a gamma 2.4, but also something else, e.g. taking into account viewing environment specifics). But also, we can take into account a particular graded look desire from a grader, and then take in the unit which determines the final luma scaling function (930), also some custom tone mapping curve from the grader, following e.g. the principles of e.g. WO2014/056679. What is important is that there is some luma curve, which will determine for this pixel, some scale factor to be used. But this topology allows us to quickly change to e.g. suddenly a new (maybe second) display connected to be serviced according to its particulars like its peak brightness, or a new grading look, or e.g. the viewer setting a different brightness preference via his remote control which will affect the brighter pixels different than the darker pixels, etc.

A useful embodiment is a video decoder (350) in which the chromaticity coordinates (u″,v″) of the input images are defined to have for pixels having lumas (Y′) below a threshold luma (E′) a maximum saturation which is monotonically decreasing with the amount the pixel luma (Y′) is below the threshold luma (E′).

This is a practical HDR encoding of the log-like luma-chromaticity type, but particularly well-suited to using it in MPEG-like en/decoding topologies, since it mitigates the high bitrate requirement issues for very dark regions, which due to the high non-linearity of the code allocation function may end up at relatively high lumas, still be rather noisy because not every camera (mentioned to be HDR by the manufacturer) used for creating the HDR content is all that high quality in its lowest luma parts, i.e. the darkest colors may contain considerable noise, which need not unnecessarily consume scarce bit budget on various transmission media (e.g. a memory product like a BD disk, or a satellite channel, or a low bit-rate internet connection, etc.) The spatial upscaling can then happen after having transformed the special novel chromaticities to legacy chromaticities which generally leads to simple and cheap topologies, or even higher quality variants which work around the novel chromaticity images, or further modifications thereof, and upsample those chromaticity images. The skilled person should sufficiently understand how a saturation would always be defined in (u,v) plane, i.e. this would be a distance from a predetermined white point (uw,vw) e.g.D65, and the distance is typically a square root of the squares of the component differences u-uw and v-vw.

A further useful video decoder (350) embodiment in processing order comprises the following units: first a downscaler (910) arranged to spatially subsample the input component image of lumas (Y′) with a subsampling factor, then a gain determiner (911) arranged to determine based on the lumas (Y″2 k) per pixel in this subsampled image a first gain (g1), then a multiplicative scaler (912) arranged to multiply the chromaticity coordinates with the first gain to yield intermediate chromaticities (u′″,v′″), in a parallel processing branch comprises an upscaler (916) arranged to upscale again the subsampled image of lumas (Y″2 k) with the same subsampling factor, and a second gain determiner (915) arranged to calculate a second gain (g2) on the basis of the lumas (Y″4k) of the re-upsampled luma image, then the primary processing branch further comprising an upsampler (913) arranged to upsample the intermediate chromaticities (u′″,v′″) to the resolution of the input component image of lumas (Y′), then a second gain multiplier (914) arranged to multiply the chromaticities of the upscaled chromaticity component images with the second gain (g2).

A further useful video decoder embodiment works on the intermediate chromaticities (u′″,v″′) defined from CIE 1976 u′,v′ coordinates, by attenuating the u′v′ coordinates with an attenuation function if the color has a luma Y″ lower than a threshold E″, and boosting the u′v′ coordinates with a boosting function if the color has a luma Y″ higher than a threshold E″.

A method of high dynamic range video decoding, comprising:

receiving a video signal (S_im) of images transmitted over a video transmission system or received on a video storage product, in which pixel colors are encoded with an achromatic luma (Y′) coordinate and two chromaticity coordinates (u″,v″), the method further comprising in processing order: spatial upsampling to increase the resolution of the image components with the chromaticity coordinates (u″,v″), secondly transform for the pixels of the increased resolution chromaticity component images the chromaticity coordinates into three luminance-independent red, green and blue color components, which are defined so that the maximum possible luma of such a color is 1.0, and thirdly transform the three luminance-independent red, green and blue color components into a luminance-dependent red, green and blue color representation, by scaling with a common luma factor calculated on the basis of the achromatic luma (Y′) coordinate.

A method of video decoding, further comprising receiving the two chromaticity coordinates (u″,v″) in a format which is defined to have for pixels having lumas (Y′) below a threshold luma (E′) a maximum saturation which is monotonically decreasing with the amount the pixel luma (Y′) is below the threshold luma (E′), and converting these chromaticity coordinates (u″,v″) to standard CIE 1976 uv chromaticities prior to performing the spatial upsampling.

Corresponding to this on a content distribution side is a video encoder (300), arranged to encode an input video of which the pixel colors are encoded in any input color representation (X,Y,Z) into a video signal (S_im) comprising images of which the pixel colors are encoded in a color encoding defined by achromatic luma (Y′) coordinate and two luminance independent chromaticity coordinates (u″,v″), the video encoder further comprising a formatter arranged to format the signal S_im further suitably for video transmission over a transmission network or storage on a video storage memory product like a blu-ray disk, such as e.g. in an format defined by an MPEG standard like AVC (H264) or HEVC (H265) or similar.

Although not strictly necessary, because a core element of our embodiments is using Yuv color encoding technology in whatever video encoding for transmission, we have designed our technologies and embodiments so that they can easily fit in legacy encoding frameworks. In particular, the formatter may just do anything as in e.g. classical HEVC encoding (pretending the Y and uv images were normal YCrCb images, which would look strange of course if directly displayed, but they're only packed into these existing technologies to be translated by color mapping to the correct images later, leading to efficient re-usability of deployed systems at least on the short term). This means the formatter will on the one hand do data reduction processing like e.g. DCT encoding and arithmetic encoding, and on the other hand fill in all kinds of header and other metadata as is typical for generating any practical variant of such HEVC encoding. The details of that are not necessary for clearly elucidating any of the present embodiments. What we do want to add is that in our HDR framework we have also invented possibilities for deriving further color gradings (or appropriate looks for a given rendering situation, e.g. on a 700 nit display starting from e.g. a 2000 nit reference luminance range encoded image according to the present Yuv encoding), which will typically happen with metadata encoding color mapping functions, several variants of which the formatter may also encode in S_im (or similarly associatable with S_im, which means that at the latest when needed for processing the metadata data can be obtained from some metadata source).

Yuv encoding is a fantastic encoding, in particular because it can encode a great many scenes, because it has—even on independent channels—both wide color gamut encoding capabilities, and more importantly a freely assignable achromatic channel, which can in contrast to YCrCb be easily tuned to whatever a particular HDR scenario may desire (even for only a single scene from a movie a dedicated EOTF for defining the to be renderable luminances from the lumas could be chosen).

The Yuv space may be even more highly non-linear than any YCrCb space, but because of the good decoupling of the chromatic and achromatic channels, problems can be better dealt with (this multiplicative system contrasting with the additive YCrCb system is also more in tune with color formation in nature in which an object spectrum models the incoming light spectrum and amount).

However, we had to solve a number of problems for being able to work with this system (like the noise problem in particular for the darker colors which was seen as a serious problem of Yuv dissuading from contemplating having any good use for this Yuv in practical video codecs), but that also brought further advantages.

As we will see in some below embodiments, one can design systems in which any color manipulations, whether of a technical nature such as conversion to another system, or of an artistic nature like color grading, are done in separate units and parts of the physical apparatus (e.g. an IC) on respectively the achromatic channel for e.g. dynamic range transformations (e.g. obtaining an LDR look by brightening an HDR graded image at least for its darkest parts), or the chromatic channel for purely chromatic operations like saturation change for visual appeal or color gamut mapping, etc.

Due to the meaningful decorrelation of the chromatic and achromatic information in images of scenes, we also found good compression behavior, as our embodiments achieved high visual quality for similar bit-rate compared to other systems for encoding HDR which very recently emerged (like the system of Dolby), and we managed to mitigate problems of those systems like color crosstalk, which e.g. leads to the fact that in a zebra pattern of dark blue lines and light grey ones, the dark blue color upon subsampling influence the final subsampled color more than they should, leading to incorrect colors. In several embodiments we also managed to configure the processing pipeline so that operations can be done in color spaces which need smaller word lengths for encoding the values to be e.g. added, or multiplied, than other systems, like e.g. YCrCb or linear color ones.

So a core advantage is that a Yuv codification is transmitted, and in particular, one can define this signal so that no luminance information is lost, so that at least there is no issue of not knowing at the receiver side what information exactly was lost in e.g. the achromatic channel, which would affect even the smartest future algorithms trying to reconstruct the original image with best quality, in particular highest sharpness, and least color change (e.g. the wrong hue or saturation of at least small regions) or bleed.

A useful embodiment of the decoder comprises a chromaticity basis transformation unit (352) arranged to do a transformation to a new color representation, in a luma-scaled 2 or 3-dimensional color representation, which new color representation is preferably a luma-scaled (R,G,B) one. This has the advantage that one can keep doing all color processing in the simple spaces, which may need smaller bit words, simpler processing (e.g. 2D LUT instead of 3D, etc.). With a 2-dimensional luma-scaled representation we mean one which has only two coordinates, e.g. R′/Y′ and G′/Y′ (also u,v can be seen as a luma-scaled representation, be it diagonally to the diagonal color plane), and a three-dimensional one is e.g. (R-Y)/Y, (G-Y)/Y, (B-Y)/Y (i.e. in fact everything resides in a 2D space, but we introduce a third redundant coordinate because we need it when going to 3D color space) . We can therewith already map to an ultimately required device-dependent color representation. Although Yuv can in principle handle all colors humans can see and natural objects can theoretically make e.g. with lasers, practical color sets are typically defined with multiple primary systems, like e.g. RGB, or RGBYel with an extra yellow (display driving or camera measured) coordinate etc. So our (input) colors may actually all fall in e.g. the Rec. 2020 gamut. But that is not necessarily so important, more important is that to use the colors we have to map them to a device dependent representation, typically RGB (or typically already R′G′B′ taking into account the appropriate display EOTF). So the decoder (in whatever actual technical configuration or apparatus or system of apparatuses it actually manifests itself) needs to do some color basis transformation to the particular RGB primaries of say an OLED display or LCD projector.

Other useful embodiments, whether solely manifesting the present additional technological solution or combined with any of the previous principles, comprise a spatial upsampling unit (353), arranged to increase the resolution of an input image of pixels with a chromaticity coordinate (u″) by applying an interpolation function to obtain pixel values intermediate to those of the input image, the spatial upsampling unit (353) being situated at a position in the color processing pipeline before the scaling unit (356). Typically in current and probably many future video encodings the color channels are subsampled, so because the available structure for presently handling the Cr Cb color component images is currently e.g. 4:2:0 subsampled, so will our uv components need to be, if we want to process and store them in the system available in legacy systems like AVC or HEVC. That means however that we will lose some resolution in the chromatic information. But the beauty of later multiplicatively scaling with the achromatic brightness-determining high resolution image, is that in contrast to YCrCb systems we retrieve nearly all our original sharpness. Note that although we elucidated with an example of 4K ultra-HD as coded resolution, our invention also works with higher or lower resolutions, e.g. to improve by this special Yuv color handling the ultimate sharpness of normal HD (2 k) signals, whether with an LDR or HDR luminance dynamic range. So Yuv encoding as well as the specific embodiments for signal processing at encoder or decoder taught herein work also well when desiring to improve LDR systems, although they were primarily invented and designed for HDR encoding.

Advantageous embodiments of the decoder comprise a dynamic range scaling unit (356), allowing to convert a luma-scaled color representation ((R-Y)/Y) to a luma-dependent color representation ((R-Y)). So after having done all desired processing in a “dynamic-range-blind” luma-scaled representation, we may finally convert to the desired dynamic range. And this need not be fixed (e.g. a 5000 nit reference luminance space, or a linear RGB driving therein, or R′G′B′ driving coordinates representation enabling rendering on display of colors in this reference space), but may be a space which is optimally determined to drive e.g. a 1000 nit medium dynamic range display. So all the brightness processing required for an optimal look on such a display can be done by applying the desired luma values to the multiplication 356, e.g. via an optimally chosen EOTF 354.

Although some embodiments may go to a linear RGB color representation (some displays may prefer such as input if our decoder resides in e.g. a settopbox), other embodiments as shown e.g. in FIG. 9 can group needed calculations in a by-pass towards display-gamma space Y′ directly (discriminated from Y″, which is typically the for coding optimal perceptual luma space, i.e. in which we have used e.g. a loggamma EOTF rather than a gamma 2.2 one). This allows also to use word lengths like e.g. 12 bit for R/Y components, e.g. 12-14 bit for R′/Y′ components (which is an efficient representation compared to e.g. pure linear color space calculations which may need 24 bit words for the components like R), as well as 12 bit for Y′_4 k calculated values, and 12-14 bit for R′ display driving color coordinates. Our Y″ values corresponding to the Y′ values may typically be faithfully encoded in only 10 or 12 bit. Also the various operations to go from u′v′ representation to e.g. R′/Y′ etc. may be in some embodiments be realized via a (possible selectable amongst several for different situations) 2D-to-3D LUT, whereas other embodiments may do function calculations, which functions might be on the fly parametrizable.

Note also that we have several variants of u,v which should not be confused. The single dash u′ was already given to the u′v′ notation standardized by the CIE in 1976. We note with double dash u″ our version which is a Crayon-space redefined uv space, i.e. with a tip getting gradually smaller for the darker colors.

Denoted with triple dashes u′″,v′″ is an entirely different color space again. It is not really a u,v-based (cylindrical) space anymore, although it still retains some aspects like the particular horseshoe shape. But we make it conical again because we desire (internally, when doing upsampling only, not in the signal transmission e.g. by broadcast) to have some luminance-dependency again in the upsampling, which ideally should happen in linear space.

This Y″u″′v′″ space or its corresponding u″′,v″′ planes are unlike anything in current color technology. They depend on whatever we define to be the now achromatic Y″ axis (as said in principle this needn't even be continuous, and we could e.g. define the sun to be at code 1020, where code 1019 is representing a 10000× darker luminance). So the code maximum (Y″max) could be anything, and the codes below it can represent any luminance distribution sampling. So the cone may be a highly non-linear one (although simple linearly varying with luma Y″, it may be severely bent when drawn in a space with luminance on the third axis), but still it retains the property that the u′″ and v″′ values grow with the luma of the pixels they belong to, which is as we will elucidate with FIG. 9 a very useful property to obtain better quality upsampling leading to e.g. less dominance of the contribution in the final colors of darker colors in high frequency structures.

Other interesting embodiments are e.g.:

A method of video decoding, comprising:

receiving a video signal (S_im) encoded in a format suitable for transmission over a video transmission system or reception on a video storage product, and received either via such a transmission or storage product connection, in which pixel colors are encoded with an achromatic luma (Y′) coordinate and two chromaticity coordinates (u″,v″), and

transforming the chromaticity-based colors in a luma-dependent color representation, by scaling with the achromatic luma.

A method of video decoding comprising prior to the scaling to the luma-dependent color representation transforming the input chromaticity coordinates to another luma-scaled color representation, such as e.g. (R/Y,G/Y,B/Y).

The skilled reader should herewith understand that several mappings to several possible interesting color representations are possible, but we elucidated a useful one of the RGB-family. If a receiving device directly desires a universal e.g. XYZ color encoding, the decoder may not go via RGB, but in some variants it could e.g. go to UVW.

A method of video decoding comprising applying a non-linear mapping function such as e.g. a power function to a luma-scaled representation of additive reproduction color channels (R/Y,G/Y,B/Y) to obtain another luma-scaled representation (R′/Y′,G′/Y′,B′/Y). In this manner we can already pre-transform to e.g. desired non-linear characteristics of a rendering systems. We precalculate what is possible already as an equivalent non-linear mapping in the unitary color plane 601, which was not contemplate before but has several advantageous such as less costly calculations.

A method of video decoding comprising doing in processing sequence succession first a spatial upscaling to the luma-scaled color representation, and second scaling to a luma-dependent color representation. This gives us a simple upscaling in the chromatic part, yet a recovery of nearly full resolution from the achromatic encoding (Y″_4 k).

A video encoder (300) comprising a spatial downsampler (302) working with an input and output signal encoded in a linear color space (X,Y,Z). This guarantees that the downsampling is done in the right linear space (not non-linear YCrCb e.g.), i.e. because these XYZ signals are optimally sampled, so will the representation u′,v′ derived from it be.

At the decoder side however we deliberately designed an optimal embodiment to do the upsampling on the highly non-linear chromatic signals (like e.g. u,v in some embodiments), but as we elucidate below we designed our technology to do that well.

A method of video encoding comprising:

receiving as input a video of which the pixel colors are encoded in any input color representation (X,Y,Z); and

encoding that input video into a video signal (S_im) comprising images in which the pixel colors are encoded in a color encoding defined by achromatic luma (Y′) coordinate and two luminance-independent chromaticity coordinates (u″,v″), the video signal S_im further being suitably formatted for video transmission over a transmission network or storage on a video storage memory product, like e.g. a blu-ray disk.

A computer program product comprising code which enables a processor to execute any method realizing any embodiment we teach or suggest in the teachings of this text.

All these embodiments can be realized as many other variants, methods, signals, whether transmitted over network connections or stored, computer programs, and the skilled reader will understand after understanding our teachings which elements can be combined or not in various embodiments, etc.

### BRIEF DESCRIPTION OF THE DRAWINGS

These and other aspects of the method and apparatus according to the invention will be apparent from and elucidated with reference to the implementations and embodiments described hereinafter, and with reference to the accompanying drawings, which serve merely as non-limiting specific illustrations exemplifying the more general concepts, and in which dashes are used to indicate that a component is optional, non-dashed components not necessarily being essential. Dashes can also be used for indicating that elements, which are explained to be essential, are hidden in the interior of an object, or for intangible things such as e.g. selections of objects/regions (and how they may be shown on a display).

In the drawings:

FIG. 1 schematically illustrates the two different topologies for prior art color spaces, cone and cylinder;

FIG. 2 schematically illustrates an exemplary communication system for video, e.g. over a cable television system, and an embodiment of our encoder, and an embodiment of our decoder;

FIG. 3 schematically illustrates a new crayon-shaped color space we introduced, which is useful for encoding colors, in particular when data compression of a kind identical or similar to DCT encoding is involved;

FIG. 4 schematically shows other embodiments of our decoder, which can be formed by switching the optional dashed components in our out the connected system;

FIG. 5 schematically shows the corrective mathematics applied for optimizing the colors in the lower part of the crayon-shaped color space, which corresponds to the action of unit 410;

FIG. 6 gives some geometrical elucidation of some of the new colorimetrical concepts we use in our video or image encoding;

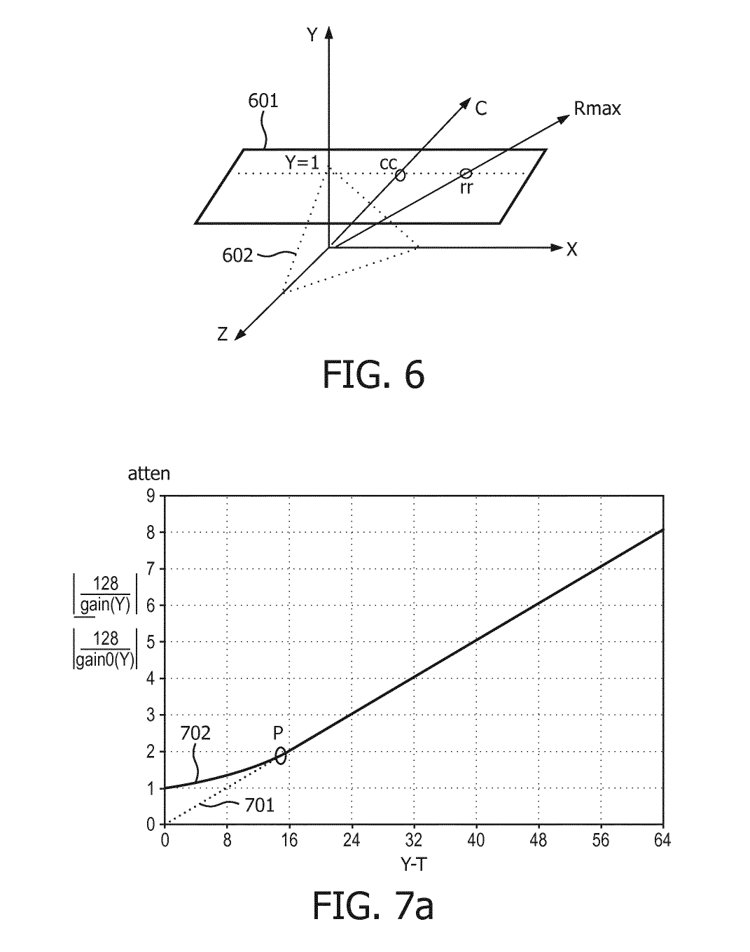

FIG. 7 schematically shows some additional ways in which we can define useful variants of the Y″u″v″ Crayon color space with various sharpness or bluntness (and width at black) of their tips;

FIG. 8 schematically shows just an elucidating example of how one typically can determine the epsilon position where our cylindrical crayon upper part starts its tip which shrinks towards (u″,v″) colors of small saturation, i.e. shrinks towards some white point, or more accurately some black point;

FIG. 9 schematically shows another possible decoder (in a system with encoder), which inter alia scales the tip with an attenuation dependent on Y″ rather than e.g. Y, and introduces the reshaping of the Crayon into a cone-shaped space yielding the (u′″, v′″) chromatic coordinates;

FIG. 10 schematically shows two gain functions as typically used in such an encoder;

FIG. 11 schematically shows a simpler decoder scheme;

FIG. 12 schematically shows a decoder which inter alia yields linear R,G,B output;

FIG. 13 schematically shows the triple dash u″′,v″′-based space and plane, which for lack of existing wording yet required simplicity of reading we will name “Conon space” (contraction of conically shaped Crayon-tipped uv space); and

FIG. 14 schematically shows a preferred to standardizedly use embodiment to resolution scale chromaticity coordinates u′v′, or other color coordinates like e.g. Y.

### DETAILED DESCRIPTION OF THE DRAWINGS

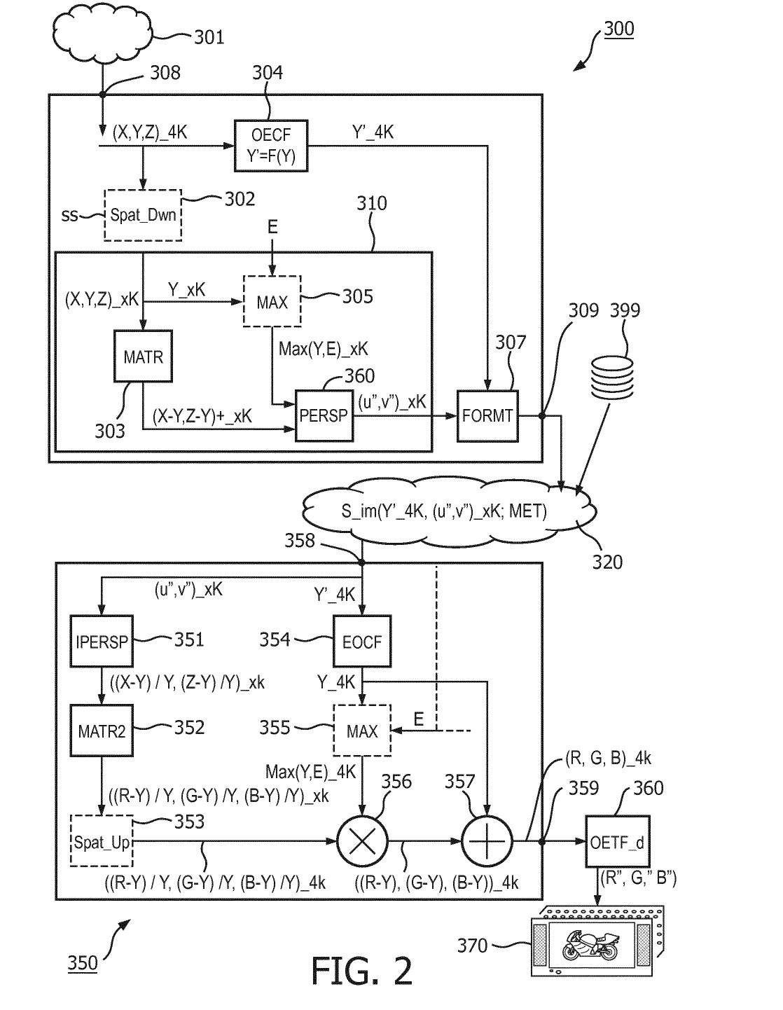

FIG. 2 shows a first exemplary embodiment of an encoding system (encoder but also a possible accompanying decoder) according to the newly invented principles and conforming to the new Crayon-shaped Y″u″v″ color space definition, with a video encoder 300, and a particular decoder 305. We assume the encoder gets video input via input connection 308 from a video source 301 which already supplies video images in the CIE XYZ format, which is a device independent linear color encoding. Of course the decoder may comprise or be connected to further units which do typical video conversions, like e.g. map from an OpenEXR format, or some RAW camera format etc. When we say video we assume the skilled reader understands there may also be video decoding aspects like e.g., inverse DCT transformation involved, and anything necessary to yield a set of images in which the pixels have colors encoded as (X,Y,Z), which is the part which is needed to explain the details of our invented embodiments. Of course the equations we present below starting from (X,Y,Z) can also be derived for starting from another linear color space like e.g. a (R,G,B) with the RGB primaries standardized, but we will explain our embodiments starting from the universally known CIE XYZ space. As to the artistic part, we will assume the source 301 delivers a master HDR grading, which would be e.g. a movie re-colored by at least one color grader to get the right artistic look (e.g. converting a bland blue sky into a nice purplish one), but the input may of course be any set of temporally consecutively related images, such as e.g. camera RAW output, or a legacy LDR (low dynamic range) movie to be upgraded, etc. We will also assume the input is in a high quality resolution like e.g. 4K, but the skilled reader will understand that other resolutions are possible, and especially that our embodiments are especially well-suited to deal with various resolutions for the different color components.

Typically, though optionally, a spatial subsampling unit 302 will down convert the signals before the determination of the color information in chromaticities is performed, since the eye is less acute for color information, and therefore one can save on resolution for the chromaticity images, and e.g. interleave the two chromaticity component images in a single to be encoded picture (we have developed our system so that this further encoding can be done with legacy coders, like e.g. MPEG-like coders like an AVC encoder, i.e. by doing DCT-ing etc.). E.g., the spatial subsampling unit (302) may use a subsampling factor ss=2 in both directions, to go from 4:4:4 to 4:2:0.

Now this original or reduced resolution (X,Y,Z)_xK signal (where x signifies an arbitrary resolution, e.g. from an 8K original to a 2K input for determining the chromatic information) is input for a chromaticity determination unib 310. In our embodiments we don't use a chrominance-type color space, but a chromaticity-based one, because this has some very advantageous properties. However, the standard chromaticity spaces (i.e. a chromaticity plane+some luminance or luma or lightness axis) cannot be used well, especially for HDR video encoding.

Although in principle other chromaticity plane definitions could be used, we will assume in this elucidation that we base our definition on CIE's 1976 Y′u′v′ space, or more precisely the chromaticity plane thereof, which we will however reshape by a new definition of the chromaticity coordinates which we therefore will indicate with double primes (u″,v″).

If one were to use the classical CIELUV 1976 definition (reformulated usefully):

$${u}^{′} = \frac{4 * \frac{X - Y}{Y} + 4}{1 * \frac{X - Y}{Y} + 3 * \frac{Z - Y}{Y} + 19} \\ {v}^{′} = \frac{9}{1 * \frac{X - Y}{Y} + 3 * \frac{Z - Y}{Y} + 19} \qquad [ Eq . 1 ]$$

the resulting color space and the therein encoded colors would have some good properties. Firstly, one very powerful and usable property is that one has decoupled luma (i.e. the coordinate which encodes the luminance, or psychovisually restated brightness), from the pure chromatic properties of the color (i.e. in contrast with chrominances, which also still contain some luminance information). But thinking and experimenting further over the last years, the inventors and their colleagues got deeper insight into that this decoupling has a property which is of major importance for especially HDR video encoding: one can use any code allocation function or opto-electronic conversion function EOCF to encode required luminances (whether those captured by camera or a grading thereof, or the ones to be outputted by a display receiving the video), e.g. very high gamma ones, or even bending ones like S-shapes, or even discontinuous ones (one can imagine the luma to be some “pseudo-luminance” associated with the chrominances). This “don't care property” also means we can decouple some of the desired processing (whether encoding, or e.g. color processing, like re-grading to obtain another look) in the chromatic “unit-luminance” planes only, whatever the bending of the luminances along the luma axis. This also led to an insight that HDR encoding, and even the encoding of other looks (tunability to the required driving grading for e.g. a medium dynamic range display which needs to optimally rendered some HDR image of different dynamic range) becomes relatively simple, as one needs one image to encode the spatial object texture structures, which can be done with the (u″,v″) and some reference shading (Y′), and one can convert to other lighting situations by doing first a dominant redefinition of the Y′ (e.g. a quick first gamma mapping) and then the further needed processing to achieve the optimal look in the (u″,v″) direction.

So we will assume that the opto-electronic conversion unit 304 applies any preselected interesting color allocation function. This could be a classical gamma 2.2 function, but for HDR higher gammas are preferable. Or we could use Dolby's PQ function. Or we may use:

$${Y}^{′} = {( \frac{{e}^{m , v} - 1}{m} )}^{γ} \qquad [ Eq . 2 ]$$

in which m and gamma are constants, and v is defined as (Y-Y_black)/(Y_white-Y_black).

Note that the arbitrariness of the achromatic axis means that in principle we could also use linear luminance, and could reformulate e.g. our encoder claim by using a luminance thresholding definition instead of a luma one. So in the decoder of FIG. 2 input Y′ is typically with some optimal HDR EOTF (which corresponds roughly to very high gammas like e.g. 8.0), and the double dash indicates e.g. red or Y″ values in the gamma 2.2 display domain. Notice that our principles could equally work for encoding LDR luminance range material by using a gamma 2.2 (rec. 709, BT 1886) definition for the EOTF of Y′ on the decoder input, as well as other variants.

Another advantage of this encoding, is that the chromaticities stay within the same width dimension whatever the luminance. This means that in contrast with chrominance-based color spaces, we can always use the same amount of bits for encoding the chromaticities, and, have a better precision all along the vertical traversing of the color space. In contrast to the Y′DzDx color encoding, which needs more than 10 and preferably 12 bits for the chromatic components, we can get high quality with only 10 bits, and even reasonable quality with 8 bits. We can e.g. allocate the bits evenly over the maximum range of possible chromaticities, u=[0.0.7], v=[0.0.6], or a little tighter bounding, e.g. [0.0.623], [0.016, 0.587] (we could even clip off some infrequent very saturated colors, but for wide gamut encoding it may be useful if all possible physical colors are comprised).

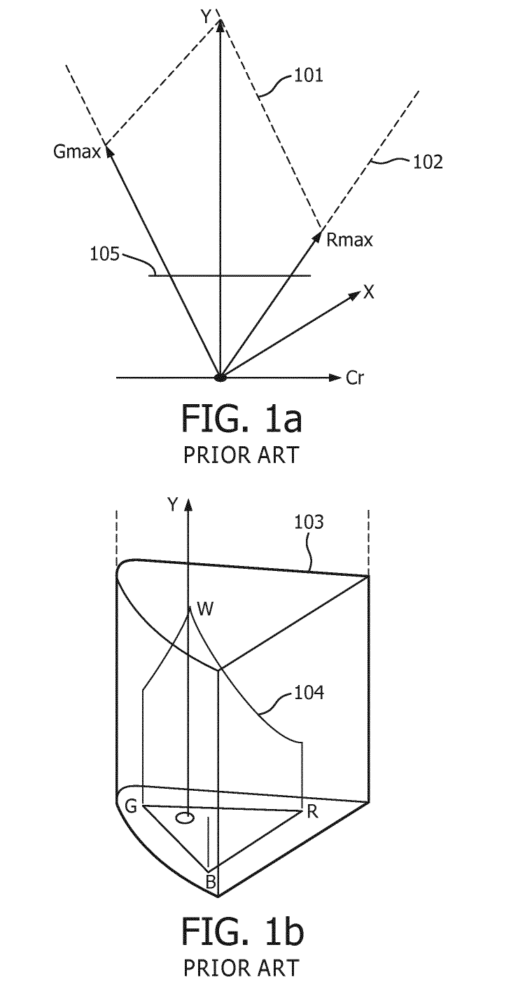

Another advantage of the decoupling is that this elegantly realizes the desire of not only having a HDR (i.e. bright luminances and/or large luminance contrast ratios) encoding, but also a wide gamut color encoding, since (u″,v″) can encode any chromaticity realizable in nature. Where in our new crayon-shaped color space definition an RGB display would have a tent shape like in FIG. 1b but with its bottom part now fitted (squeezed) in the bottom tip, we could also use our encoded colors to drive a multiprimary display made of e.g. red, yellow, yellowish-green, green, cyan, blue, and violet lasers, which may render very saturated and bright colors.

Another major issue solved, because we really have only the chromatic information in the chromaticities, is that we can avoid large color cross-talk problems which occur at color boundaries, especially in classical chrominance-based television encodings (e.g. a stripe pattern of 1 pixel wide dark red and light grey lines, or complementary colors), e.g. when subsampling is involved. Using Y′DzDx space may introduce major color errors (e.g. a dark red/light grey line interleaving converts to a weird bright orange color). Our implementation of doing first the subsampling in the linear XYZ domain, and then using our (u″,v″) creates normal colors despite the 4:2:0 encoding of the chromatic information.

A disadvantage of a such a cylindrical Y′u′v′ encoding is however that because of the division by Y (or actually by (X+15Y+3Z), the dark colors become very noisy, which increases the bit-rate required by the transform-based encoder. Therefore we have redefined the color space definition, and hence the corresponding perspective transformations defining the mapping from (X,Y,Z) to (u″,v″), so that the encoder can elegantly handle this problem with the new video encoding, i.e. without resorting to all kinds of further tricks like e.g. denoising etc.

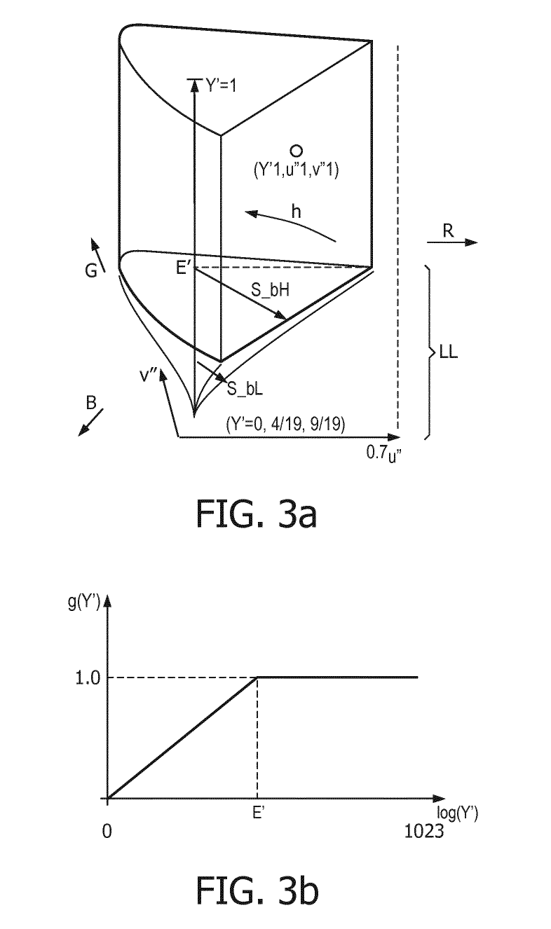

Our new perspective transformations lead to a crayon-shaped color space as shown in FIG. 3a. The bottom part has been shown exaggerated in size to be able to draw it, as the tapering tip will only occur for the darkest encodable colors, falling in the bottom part LL. With this part corresponds a predetermined threshold luma E′, and in view of the separation of the luminance direction and its ad libitum choosable OETF, with any choice E′ also corresponds a unique value of threshold luminance E, which can be determined by applying the inverse of the OECF function, i.e. the EOCF (electro-optical conversion function) to E′. E or E′ may e.g. be fixed in the hardware of encoder and decoder (a universally usable value), or it may be selected per case, and e.g. co-transferred with the signal, e.g. stored on a BD disk storing the video. The value of E may typically be within the range [0.01, 10] or more preferably [0.01, 5] nit, converted to the unitary representation via division by peak white of the color space. So the fact that no color encoding for a particular input color can occur with a chromaticity larger than (u_xx,v_xx), can be more precisely stated by stating that the boundaries of the gamut in the crayon tip shrink towards a fixed value. This can be mathematically defined by using the saturation sqrt(du″2+dv″̂2), where du″=u″−u″_w, dv″=v″−v″_w, and (u″_w,v″_w) is the chromaticity of a reference white. The horseshoe-shaped outer boundary of the gamut determines for each hue (angle) a maximum possible saturation (for a monochromatic color of that dominant wavelength or “hue”). As we see these outer boundaries stay the same for colors with lumas Y′ above E′, but become smaller for colors with lumas below E′. We have shown how the maximum saturation for a purple color stays the same S_bH above E′, and in the exemplary embodiment of this crayon color space decreases with Y′, and renamed as S_bL, below E′. This has the advantage that however noisy, this redefined small chromaticity for dark colors cannot consume too many bits. On the other hand, above E′ we find the nice properties of chromaticities, i.e. their perfect and nicely uniformly scaled decoupling from the luminance information.

So the encoder has to apply a perspective mapping to obtain u″, v″ which realizes this behavior (any definition of the equations realizing this will fulfill the desired characteristics of our new encoding technology). One way to realize this is shown in FIG. 3b, and has the encoder apply a non-unity gain g(Y′) to the saturations of colors with lumas below E′. Preferably a decoder then applies the inverse gain (i.e. if g_encoder is 0.5 then g_decoder is 2.0) to obtain the original color saturation for the reconstructed colors.

We have shown a linear example, but other functions can be used, such as e.g. : g(y)=0 if y<0; g(y)=y*(2-y) if 0<=y<e, g(y)=1 if y>=e, in which y is any suitable representation of the luma Y′. Or a lookup table may be used for gain(Y′).

So the chromaticity space formulation can be done as: (u″,v″)=(u′_w,v′_w)+g(y)*[(u′,v′)-(u′_w, v′_w)], in which (u′_w, v′_w) is the chromaticity for some predetermined white point.

An advantageous embodiment to realize the crayon-shaped color space would recode the definition of the lower luminances in the perspective transform defining the chromaticities.

$$\frac{4 * ( X - Y ) + 4 * G ( Y )}{1 * ( X - Y ) + 3 * ( Z - Y ) + 19 * G ( Y )} \\ \frac{9 * G ( Y )}{1 * ( X - Y ) + 3 * ( Z - Y ) + 19 * G ( Y )} \qquad [ Eqs . 3 ]$$

If we define an appropriate G(Y) function, i.e. the appropriate shape in the lower Y regions, we can tune the chromaticity values according to desire, i.e. the width profile of the crayon tip there. So we see the chromaticities are derived from linear color imbalances (X-Y), (Z-Y), and this G-factor which affects the scaling. For neutral colors (X=Y=Z) the tip will scale down saturation to its lowest white point (u″,v″) =(4/19, 9/19) for (X,Y,Z)=(0,0,0).

The G(Y) realization of the crayon-tip is just one easy way to realize it, as there can be other ways to do this, e.g. by using other correlate functions similar to Y or Y′, as long as the geometrical shape behavior of the encoding space gamut is similar.

A very simple possible (optional) embodiment is the one we have shown in FIG. 2, namely using Max(Y,E) as species function for G(Y).

An advantageously simple embodiment of our encoder does first a matrixing by a matrixing unit 303 to determine the X-Y and Z-Y values, e.g. in a 2K resolution image. The perspective transformation applied by perspective transformation unit 306 is then the above transformation, but in the FIG. 2 embodiment we have split the crayon-tapering by the max-function outside and performed by maximum calculation unit 305, from which the result is filled in at the place of the last terms of the perspective equations. Finally the encoder further encodes and formats according to any pre-existing (or future video encoding standard capable of being used for video transmission, e.g. an MPEG-standard) strategy in formatter 307 the images containing data Y′ and (u″,v″), and encodes this in video signal S_im, possibly together with metadata MET, such as e.g. the peak white of the reference display on or for which the encoded grading was done, and possibly also the chosen value for E or similarly E′. I.e., the formatter pretends that as in MPEG the components are a Rec.709 gamma Y′ and Cr,Cb interleaved (sub-)images although in actuality according to the principles of our inventive embodiments those will contain some u″,v″ variant of chromaticities, and whatever Y″ luma achromatic value according to whatever EOTF we care to use (e.g. a loggamma one as described in non-prepublished U.S. 61/990,138, the teachings of which are herewith included for those jurisdictions which allow this, or any other suitable EOTF for HDR image encoding, or LDR image encoding, or any other image encoding which may benefit from the present Yuv encoding). Of course the values like epsilon (E or E″) may be different for LDR or HDR.

This video signal S_im can then be sent via output 309 to any receiving apparatus on a video transmission system 320, which non-limitedly may be e.g. a memory product containing the video, like a BD disk or solid state memory card, or any network connection, like e.g. a satellite TV broadcasting connection, or an internet network connection, etc. Instead of going over any network, the video may also have been stored previously on some storage device 399, which may function as video source at any time desired, e.g. for video on demand over the internet.

Receiving this signal, we have shown in FIG. 2 a first possible embodiment of a video decoder 360, which might be incorporated in the same total system e.g. when a grader wants to check what his grading will look like when rendered in a particular rendering situation (e.g. a 5000 nit HDR display under dim surround, or a 1200 nit display under dark surround, etc.), or this receiver may be situated in another location, and owned by another entity or person. Non-limitedly this decoder 360 may form part of e.g. a television or display, settopbox, computer, digital cinema handling unit in a cinema theater, etc.

A decoder will ideally mostly (though not necessarily) exactly invert the processing done at the encoder, to recover the original color, which need not per se be represented in XYZ, but may be directly transformed to some driving color coordinates in some display-dependent color space required by a display 370, typically RGB, but this could also be multiprimary coordinates. So from input 358 a first signal path sends the luma Y′ image to an electro-optic conversion unit 354 applying an EOCF being the inverse of the OECF, to recover the original luminances Y for the pixels. Again if we have used the Max(Y,E) definition of the crayon color space, there may optionally be a maximum calculation unit 355 comprised, and otherwise the saturation decreasing is taken care of in the mathematical functions applied by the inverse perspective transformation unit 351.

This unit will e.g. calculate the following:

$$\frac{X - Y}{Y} = \frac{9 * {u}^{″} - 4 * {v}^{″}}{4 * {v}^{″}}$$

$$\frac{Z - Y}{Y} = \frac{12 - 3 * {u}^{″} - 24 * {v}^{″}}{4 * {v}^{″}}$$

I.e., these are chromatic-only quantities (n.b. one may also see them as X-Y/Max(Y,E), but that doesn't matter as they are achromatic quantities, derivable solely from the (u″,v″) chromaticities), irrespective of whatever luminance the color of the pixel has. They still need to be multiplied by the right luminance later, to obtain the full color.

The numerator of this is a linear combination of the linear X,Y, and Z coordinates. So we can do matrixing on this, to obtain linear R,G,B coordinates, still referenced by the appropriate luminance as scale factor though. This is achieved by matrixing unit 352, yielding as output (R-Y)/Y, (G-Y)/Y, and (B-Y)/Y. As known to the skilled the coefficients of the mapping matrix depend on the actual primaries used, for the definition of the color space, e.g. EBU primaries (conversion to the actual primaries of the display can be done later by gamut mapping unit 360, which also applies the OETF of the display to pre-compensate for it in actual driving values (R″,G″,B″) (e.g. this may be a display 370 which expects a Rec. 709 encoding, or it may be a complex driving scheme like e.g. for the SIM2, but that is beyond the teaching of our invention)). We have used the double prime to clearly emphasize that this is not the non-linearity of the code allocation function of the color space, but of the display, and OETF_d is the required non-linear opto-electronic transfer function of the particular connected display. If we did spatial subsampling in the encoder, an upsampling unit 353 will convert the signals to e.g. 4K resolution. Note that this upsampling has been deliberately placed in this position in the processing chain to have better color crosstalk performance. Now the linear difference values (chrominances) R-Y etc. are obtained by multiplying by the appropriate luminances, e.g. Max(Y,E). Finally by adding the linear luminance per pixel to these chrominances (adder 357), we get the linear (R,G,B) color coordinates, which are outputted on output 359.

A disadvantage of doing the calculations in linear space for HDR video is that 20 (or more) bit words are necessary for being able to represent the million:1 (or 10000:0.01 nit) contrast ratio pixels luminances.

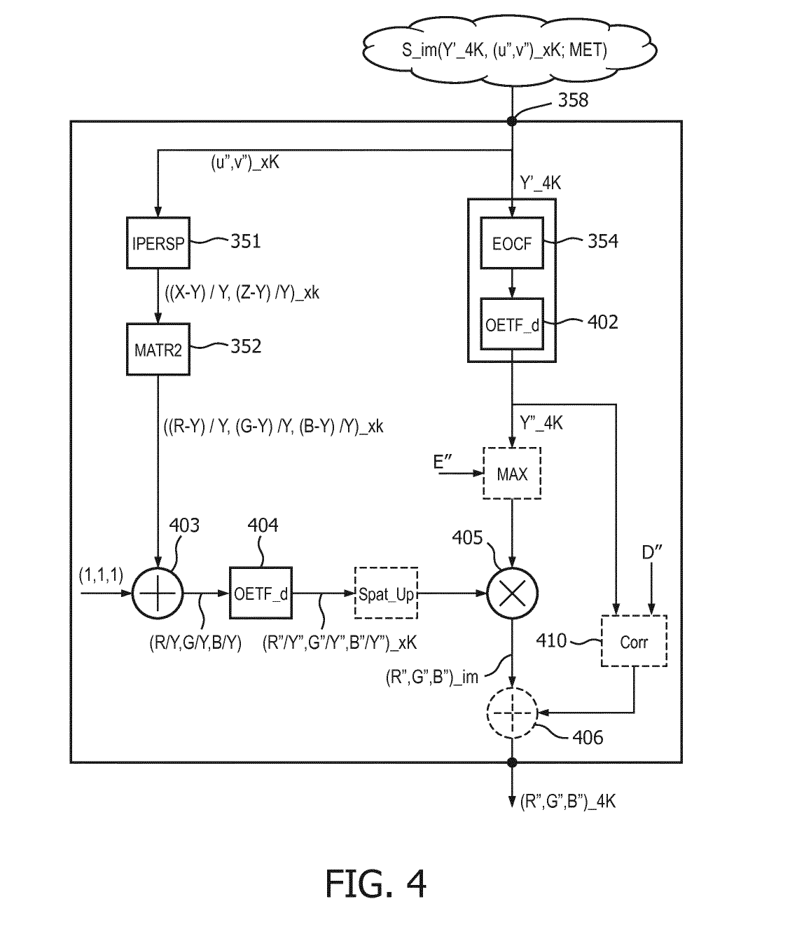

The inventors also realized that the required calculations can be done in the gamma-converted luma domain of the display, which has a reduced maximal luma contrast ratio. This is shown with the exemplary decoders of FIG. 4. So now Y′ is again defined with the HDR-EOTF, but the Crayon tip was now defined, and used in re-scaling to the actually required luma-dependent color representation (R″ etc. in display gamma 2.2 domain) in the display gamma domain, i.e., with its achromatic axis bent and re-sampled according to a e.g. 10 bit gamma 2.2 code allocation.

These decoders can work with both signals encoded in the new crayon-shaped color space, but also with signals encoded in any other Y′ab space, since the only requirement is that we decouple the Y′ axis.

The difference of decoders according to FIG. 4 with those according to FIG. 2, is that now the luminance scaling (with e.g. Max(Y,E) is done in the non-linear domain of the display, i.e. having the achromatic direction appropriately scaled for use with a particular envisaged or connected display. We need to calculate a corresponding E″, since the lumas will now be in a different representation, denoted by the double primes, which is obtained by first applying the EOCF to the lumas encoded according to the video codec for transmission (whether via storage or directly), and then the display-dependent opto-electronic conversion unit 402 (n.b. this would implement a power function, which is also why we used the wording OETF instead of OECF), yielding lumas Y″ already correct for the envisaged display (i.e. if a connected display were a black-and-white display, and driven by these Y″, the picture would look correct). In practice units 354 and 402 may of course be combined into one, e.g. applying one parametric equation, or LUT, etc. Now we see indeed that in these decoder embodiments, the multiplication is done by multiplier 405 in that new (final) Y″ luma domain. This requires a corresponding change to the chromatic pipeline, namely, the first part being the same as in FIG. 2, one first introduces adder 403, to add (1,1,1) to obtain the scaled three color coordinates (R/Y,G/Y,B/Y). These must also be transformed to the display non-linear domain, which comes out correct if one applies the appropriate e.g. 2.2 gamma (i.e. (R/Y)″=(R″/Y″)=(R/Y)̂1/2.2, etc.). If required there may again be spatial upscaling of this resultant image.

Simple decoders will ignore the Max(Y,E), and just scale with Y″, making some small color errors only for the darkest colors, which is acceptable if E is chosen small, e.g. 0.05 nit. A more advanced decoder will again apply the max function before doing the multiplication. Now preferably, an even more advanced decoder then also does a final color correction by color offset determination unit 410, to make the colors with lumas below E″ almost fully accurate, because of the non-linearities of now working in the gamma domain rather than in the linear domain.

The color offset determination unit 410 preferably determines the following:

dr=Max(0, 1−cR*Y″)*Min(Y″−D″, 0), with cR a constant, e.g. 2.0, and D″ a threshold constant, preferably equal to E″, and similarly for dg and db for the green and blue color images with their respective cg, cb

dg=Max (0, 1−c G*Y″)*Min(Y″−D″, 0),

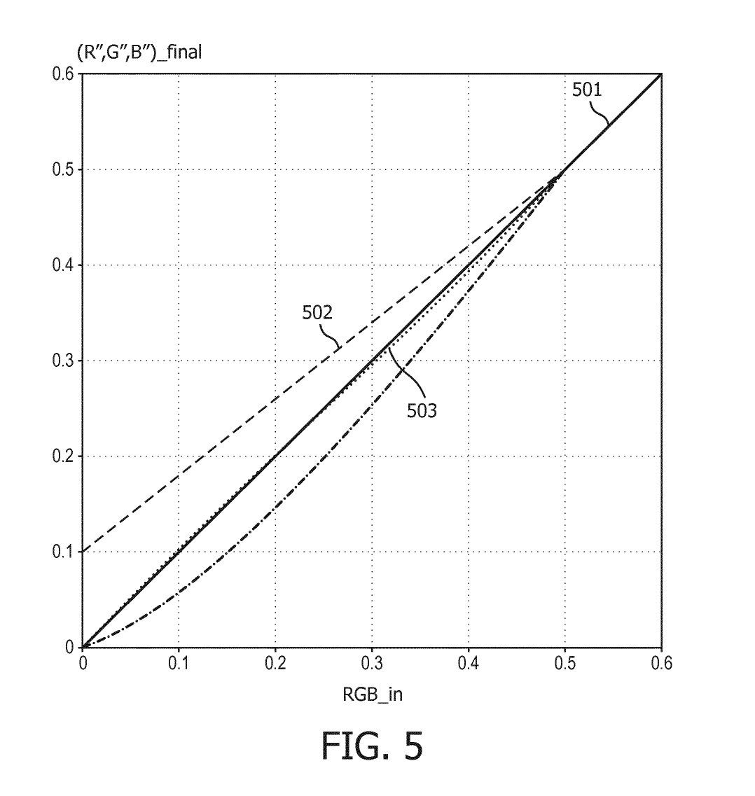

db=Max (0, 1−c B*Y″)*Min(Y″−D″, 0), to obtain a final color coordinate R″, resp. G″, B″ which is good also for the lower Y″ values. An example of this correction is shown in FIG. 5, yielding curve 501, starting from the incorrect values (curve 502) that would result from the simplified decoder which doesn't do the additional correction. The dotted line 503 is the theoretical target, and seen almost collocating with the result of the correction. The input are the intermediate (R″,G″,B″)_Im values resulting from the multiplier, and the output of the graph are the final values for output, after adder 406. The graphs show the behavior for one of the color coordinates, e.g. red.

Any decoder will finally yield the required R″, G″ and B″ per pixel for driving the display. Although our crayon-shaped color space is mostly interesting for communicating or storing video, e.g. of high dynamic range, the hardware blocks or software already being present in various devices like a receiver/decoding device, it may also be used for doing processing, e.g. grading a legacy LDR video to one more suitable for HDR rendering.

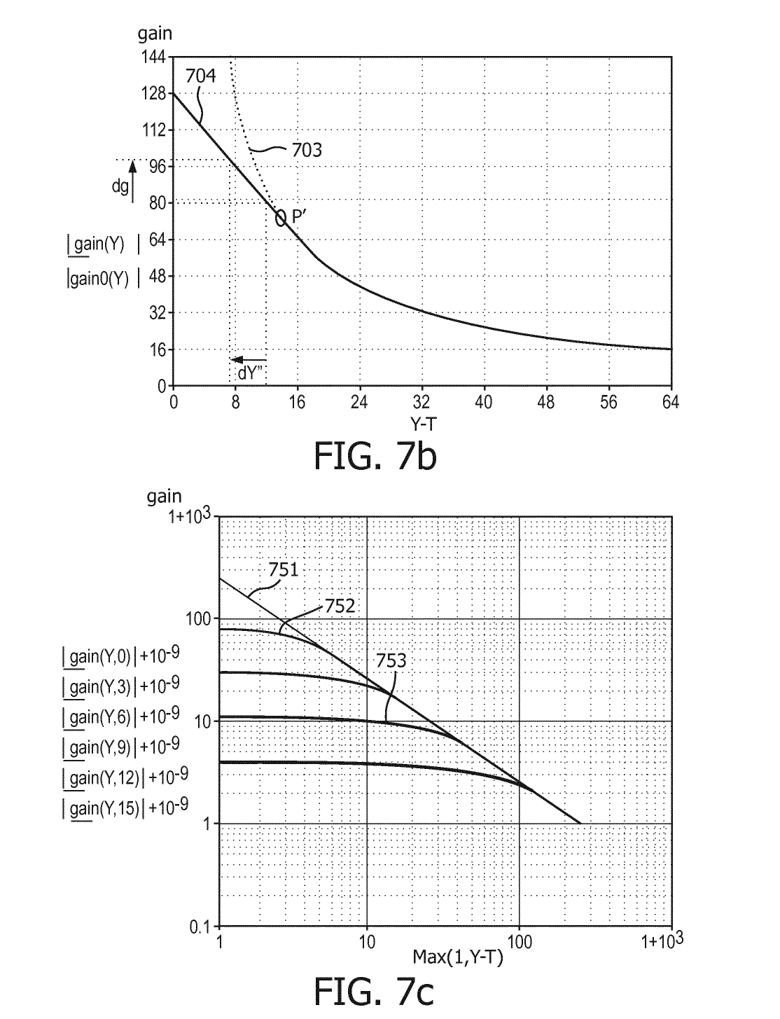

Although the Crayon version as conceptually shown in FIG. 3 works as an embodiment, one can define different and more suitable Y″u″v″ Crayon spaces. A problem with attenuating—or multiplying by Y/epsilon or Y″/epsilon″—to (near) zero is that one has to amplify with an infinite gain at the receiver. In an ultimately precise system without any errors, that would not be an issue since at the receiver side the original u′v′ (as according to CIE 1976) can be re-obtained. However in practice one has to take the typical technical limitations into account. On the one hand there will be errors du and dv on the uv coordinates, which inter alia primarily come from camera noise in the dark regions. But these were whatever the were significantly reduced by attenuation. But there can be further chromaticity errors, due to the encoding technology used. Luckily those will not be that large typically, and not too noticeable because they are just minor discolorations of what are typically already dark colors anyway, so the eye doesn't notice the difference between a somewhat greenish and somewhat bluish black so well. However a more serious concern is that there can be errors on the Y″ channel at the receiver as well, and these are more seriously already mathematically, because of them being in the multiplicative scaling. One could have serious saturation errors in the recovered u′v′, and even invalid, non-physical values. So we need to account for that using a more blunt crayon tip. In FIG. 7a we see the linear attenuation factor (just for the lower values of the luma code Y′-T where T is a black level of say e.g. 16), versus the one we clip at 1/128 (we have scaled the graph with 128 so that becomes 1).

The mathematical formula for the attenuation we will use for this is then:

Atten=clip(1, Y″/E″, 1/K), in which K may be e.g. 128.

In this we see that for the Crayon tip region where Y″ is below E″, multiplication by this division realizes a linear attenuation, which of course becomes 1 where they equal and the vertical cylinder boundaries of the Crayon continue, but we can explicitly bound the attenuation to be minimally no attenuation by multiplying by 1. The more interesting aspect is the limit to 128. Inverting the linear function (701) to obtain the amplification gain to undo the attenuation to re-obtain the correct u′,v′ values, we obtain for that multiplicative gain of course a hyperbola, which is curve 703, which we now see clipped to a maximum rather than going to infinity. So however we define the attenuation, whether clipped or unclipped, what is really important is clipping the gain of the re-boosting at the receiver (e.g. gain(Y″)=CLIP (1, E″/Y″, K=128)). Because whatever the u″,v″ values, whether e.g. (0,0) or perturbed with some small error (i.e. yielding (du,dv) instead of (0,0)), we should never boost that u″,v″ reconstruction at the receiver too much, in particular if du or dv is large. An even better strategy is then to do a soft-clipping as in curve 702, which one can easily design by making the lowest part of the gain curve follow a linear path, as in curve 704, and preferably with a relatively small slope. Not too small because then we don't attenuate the u′v′ values sufficiently, and code too much camera noise which either increases our needed encoding bit budget or creates compression artefacts in other parts of the images. But not too large a slope, because then if the receiver makes an error dY″ in its Y″ value, this can lead to a very different gain boost (g+dg) than the one needed for obtaining the correct u′,v′ pixel color, i.e. yielding an oversaturated reconstructed color, or because du′ needn't equal dv′ in general just some large color error. So this sloping part should be balanced either per system, or averagely fine for a number of typical future systems. That one can choose various slopes is shown in FIG. 7c (a 10 bits Y″ example with E″ about 256), in which the gain functions are now shown in a logarithmic rather than linear axis system (so the hyperbolic shape has changed). 705 is here the linear curve, an 752 a somewhat soft clipping gain curve, and 753 a somewhat more soft-clipping curve. Because this is the very definition of our u′v′ colors which are transmitted, the receiver has to know which Crayon tip function was used, i.e. this information has to be transmitted too, and there are various ways to do this. E.g. metadata in S_im may contain a LUT specifying e.g. the particular gain function the receiver has to use (corresponding to the selected attenuation function the content creator used by e.g. watching typical reconstruction quality on one or more displays). Or alternatively a parametric functional description of the function may be sent. E.g. if we know the upper regions of the crayon tip stay linear, we only need to encode the bottom-most part of the tip, and we could e.g. send the point where the soft clipping deviation starts (e.g. P′ or P), and a functional description, e.g. a slope of the linear segment, etc. In addition to these simple and advantageous variants, the skilled person should understand there can be various other ways to define the Crayon tip.

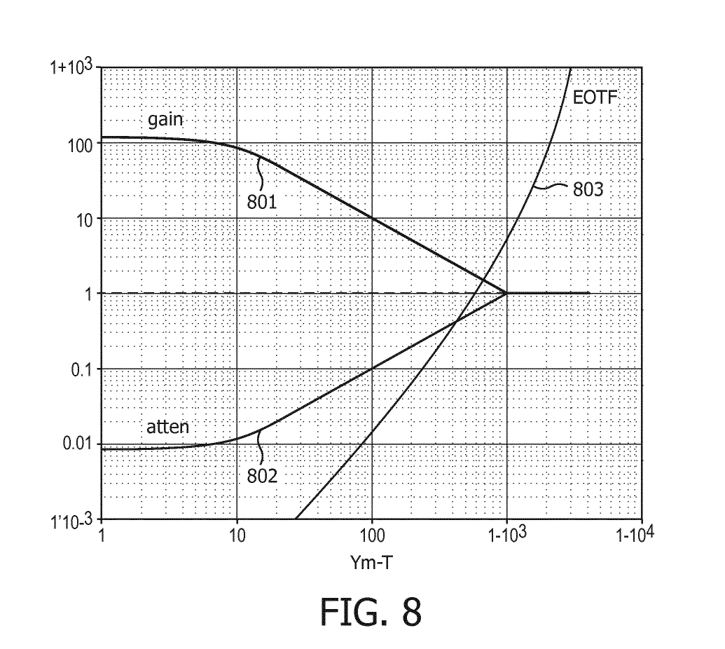

FIG. 8 gives an example on how to determine a good position for E″. We assume now that we do the tip definition with Y″ being now our HDR-EOTF defined luma, and hence so is E″. We assume we have e.g. a HDR encoding for a 5000 nit reference monitor. Assuming typical camera material with the noise around the 10 bit level, that would put it at around 1/1000 of peak white, i.e. we would assume that below 5 nits rendered on a 5000 nit display we would see a lot of noise, which would need attenuation of the u′v′ before MPEG DCT coding. We already could calculate that for a e.g. 12 bit luma (maximum code 4096), epsilon E″ would be 1024, which would put it at 25% of the code axis. That would seem high, but mind that the EOTF of HDR luma code allocation is highly non-linear, so 25% luma codes are actually pretty dark. About 5 nit, or 0.1% luma actually. This can be seen in FIG. 8 in which we have plotted our in this example preferred decoder gain function 801, and encoder attenuation function 802, together with the HDR EOTF 803. The epsilon point E″ is where the horizontal line changes into a sloping line, and from the EOTF we can read this falls on about 1000 luma code (or 25%) or 5 nit luminance. Similar strategies can be calculated if one has a much cleaner master signal, e.g. from a better future camera, or a computer graphics generator, and similar crayon tip attenuation strategies can be designed for more severe digital (DCT or other e.g. wavelet) encodings and their envisaged noise, etc.

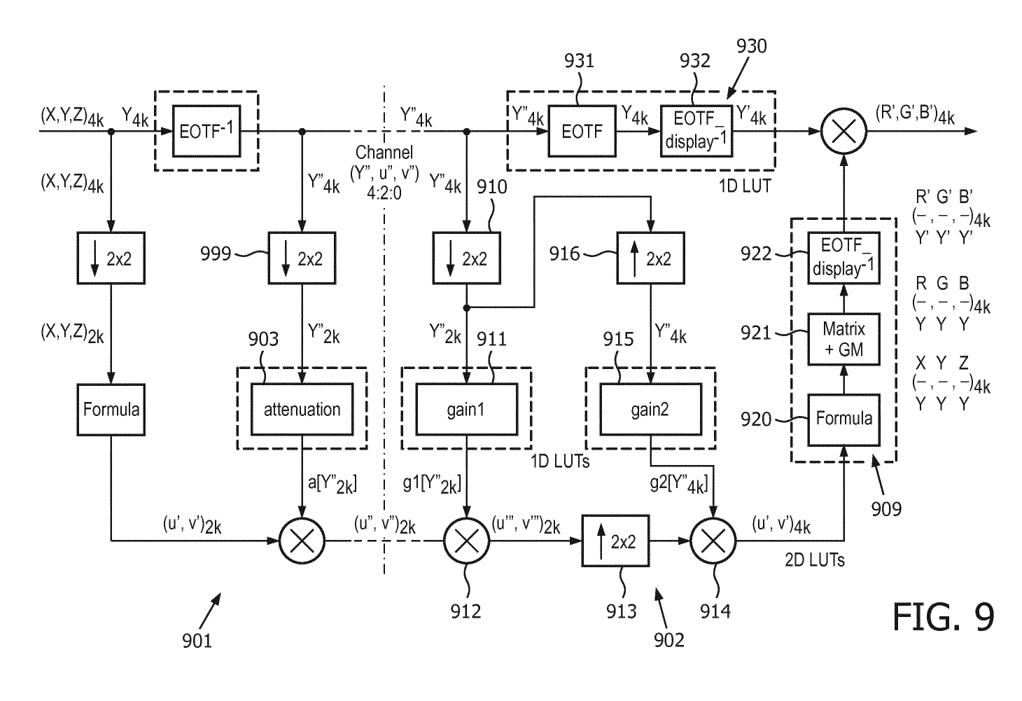

FIG. 9 shows another interesting decoder embodiment 902, inter alia introducing the u′″,v′″ concept, which solves another issue, namely the predominant influence of darker Y″,u′v′ (or u″,v″) colors in the u,v upconversion. The encoder 901 is actually the same as already described above, and uses e.g. one fixed or any variable soft-clip-tipped Crayon space definition, and its corresponding attenuation strategy in attenuation factor calculator (903).

The decoder has now some differences. Firstly, of course because we now defined the Crayon tip with Y″ here being a HDR-EOTF based luma (which after experimental research was found to work better than e.g. the luminance, because this is what actually defines the Y″u′v′ or Y″u″v″ colors). The single dash is used in this figure to indicate display gamma luma spaces. Secondly, we have moved the spatial upscaler to work conveniently in the u,v definition, but actually here in the u″′ v′″ triple dash uv plane.

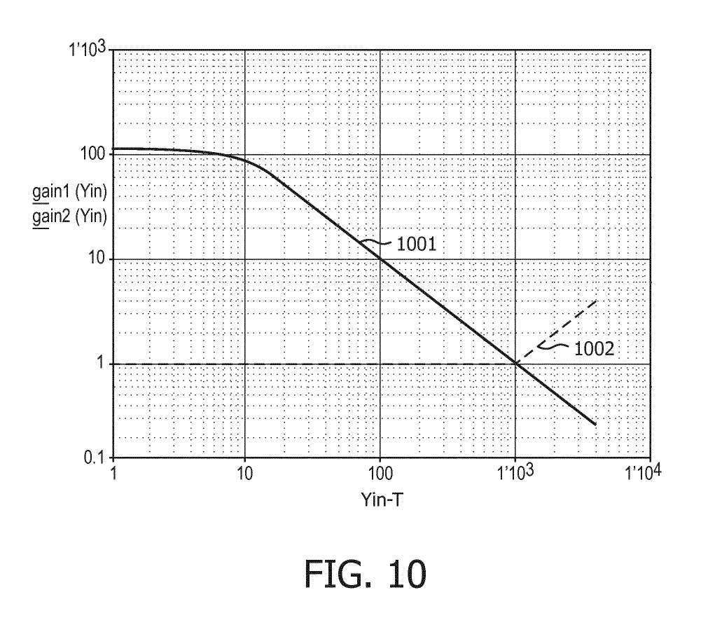

Similarly as in other decoder embodiments, down-scaler must downscale the luma Y″ received in the transmitted color encoding, which is on full resolution (e.g. 4K), to the downscaled resolution of the received encoded u″ and v″ images. Gain determiner 911 is similar to the one in FIG. 2 (355), but can now handle a more generic function. Depending on the input Y_xk value, some gain g(Y_xk) is outputted for the multiplicative scaler 912. We now preferably in this embodiment have the following gain function. Experimentally we found that if one scales with a linear function of Y″ in the tip only, and then mixes the u″,v″ values of such a scaled color with other u″,v″ values of another color, then the dark color predominates in the resultant color, which introduces errors. One may initially be inclined to think that a (u,v) image can be upsampled just like any other image, because it represents the spectral filtering behavior of the material of the scene objects, and that object spatial texture would be simply interpolatable. But the devil is in the non-linearities, which is now in the multiplication (whether object spectrum times illumination, or as in these technical representation luma-scaled chromaticity multiplied by actual pixel luma). So linear functions like geometrical resolution up- and down-scaling should really be done in linear spaces, and although we have (as said above for several reasons relating to the ability to handle images up to high dynamic luminance range) conditioned our technological embodiments to work we u,v chromatic color encoding dimensions, we need to find a strategy to make the system behave more like a linear one (at least internally in the processing chain at places where such linear behavior is required). We do this by using a gain function which doesn't stay equal to one for Y″ above E″ (as in FIG. 8), but in which the gain slope (and the gain slope of the decoder only, the encoder stays unchanged and keeps a shape like e.g. 802 which does become 1 for higher Y″, or in other words the transmission color space stays Crayon-shaped with a tip and then vertical cylinder walls) continues with the Y″/E″ multiplication beyond epsilon. It may also become some other shape for those higher Y″ values (e.g. to counteract specifics of the nonlinearity of the EOTF yielding Y″), but in research we found simple linear continuation up to Y″_max works nicely. This continued shape function for a preferred gain is shown as 1001 in FIG. 10.

Actually, because the transmitter has already applied the part of the gain strategy for Y″<E″, which is an attenuation, we only need to boost the chromaticities for pixel lumas above E″. This is implemented in the gain determiner 911 with a first gain function 1002 which yields 1 for Y″<=E″ (because those u″, v″ values were already made correct by the transmitter and we will reuse those values i.e. keep the tip shape of the Crayon space below E″ for the definition of the Conon space), but defines a linear gain boost above E″, and with the same slope i.e. Y″/E″.

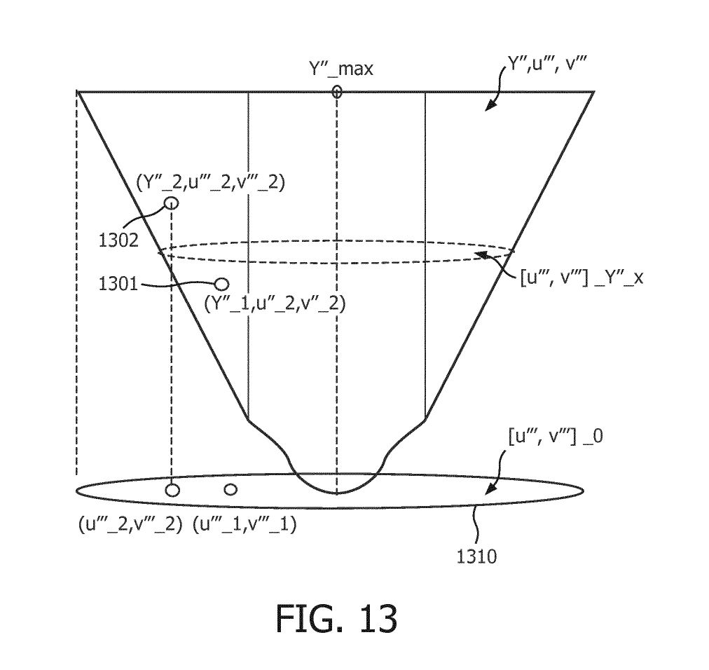

Multiplying with those gains, when seen as a Crayon space in FIG. 13, will create the color space of Y″u″ ‘v″′ which we will call Conon space. The chromaticities for colors with Y″>E″ are boosted beyond the normal range of CIE u′v′ (i.e. we now modify the definition both below E″ forming the tip, and above, forming the conical boundaries). So a color of higher Y″ (in the region above E″) is shifted diagonally in Conon space compared to the lower Y″ color, even if it has the same u′v′ or u″,v″ coordinates (which we show in FIG. 13 by giving color 1301 the u″_2 and v″_2 of the color 1302). Actually what really is used in our technology is the [u″′, v′″] color plane, and in particular the one for Y″_x being zero. So that means that a second color (u′″_2,v″′_2) with even the same chromaticity (u′v’) will lie outwards i.e. have higher values than (u′″_1,v″′_1). So now any bright color gets more weight in the interpolation compared to the dark color (where the problem was that in linear light dark colors will hardly bring any change in the mixture, but when independently from Y″ mixing their chromaticities gives them too much importance in the mix), getting the upsampling result close to what it should theoretically be. So upsampler 913 works in the Conon plane 1310: [u″′, v′″]_0. Of course to then get the correct u′v′ chromaticities back, we preferably though not for all embodiments necessary undo the boost of them for Y″>E″. This can be done by a compensating gain multiplier 914 which gets from gain determiner 915 gains from a function like 1001, which simultaneously corrects for the transmitter attenuation in the Crayon tip, and the intermediate boosting for Y″>E″. However, because this gain now has to work on the increased resolution of (u′,v′)_4 k, we need a 4 k resolution Y″ image. Although other variants can be implemented, we found the quality is best if an upscaler 916 upscales the downsclaed Y″_xk image from downscaler 910 again. Note that now both encoder has downscaler 999, and decoder downscaler 910 for the Y″_4k, and preferably those use the same algorithm, which preferably is standardized. Metadata in the signal can define one or several indexable downscaling algorithms, but because this is at the core of our Crayon space definition, preferably only one variant is standardized. E.g. the metadata specifies UV_DOWN=[1,1,1,1], and UV_UP={1,3,9}. In general this will be a unique identifier of the function, and a set of weights.

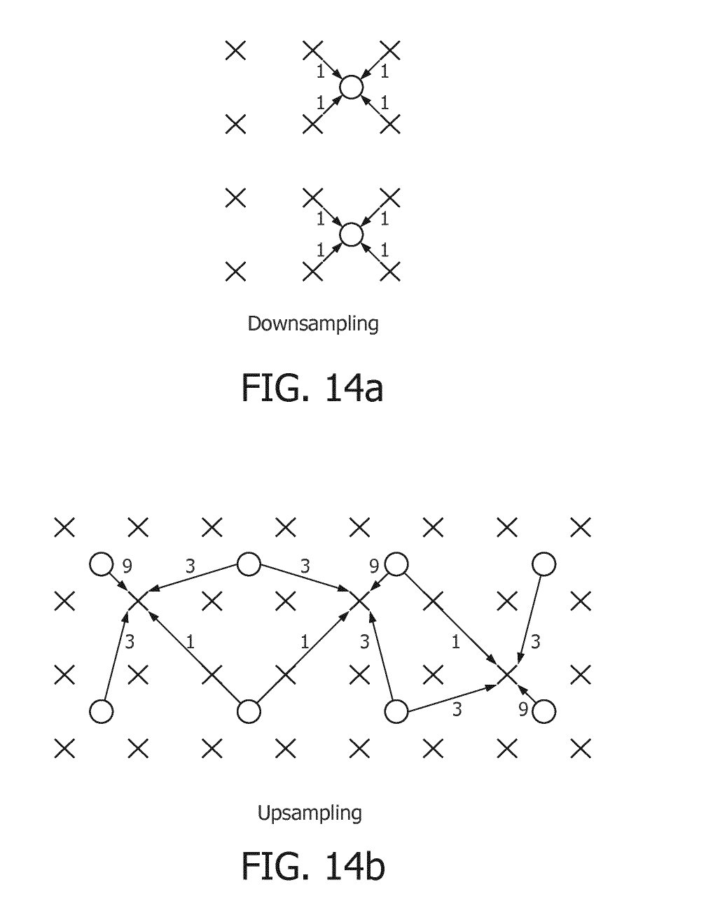

We have shown a preferred algorithm in FIG. 14. For downsampling we can just position the downsampled u′v′ values in the middle, using a filter with all 4 taps equal to ¼th. For upsampling we can use taps depending on how close each upsampled point is to the closest neighbor on the downsampled grid (see FIG. 14b), e.g. in proportion 9 to one for the closest versus the farthest, etc.

Now behind the upscaling, where we are back in the recovered Y″u′v′ space, also a number of interesting things can be done. We can in general first do all desired chromatic transformations in any luma-scaled color representation. And then do any brightness affecting transformation, like a dynamic range transformation to some generic or specific (e.g. map to 1500 nit MDR display) situation with its corresponding luma-dependent linear or non-linear trichromatic color space. In decoder embodiment 902 we show a cheap way to directly map to the gamma-domain display driving coordinates R′G′B′ of some display. Exemplary this may involve color transformer 920 (in this exampled arranged to map to X/Y, i.e. bringing the uv back to a luma-scaled XYZ-based 3D color plane definition, or some other transformation), color transformer 921 (in this example projecting to the color representation R/Y etc.), non-linear color mapper 922 (in this example arranged to apply a non-linear mapping between luma-scaled color planes from R/Y to R′/Y′ which in fact implements in this representation the conversion of a display OETF (or in fact inverse EOTF, i.e. inverse gamma, i.e. e.g. a square root). Because of the beautiful decoupling of our Y″u″v″ system, all required achromatic processing can also be grouped as one final mapping (e.g. a LUT), implemented by tone mapper 930. In this case we have loaded it with conceptual sub-units 931, which remaps between our HDR-EOTF defined luma codes Y″ and luminances Y, and a mapping 932 towards display space Y′ by applying the OETF for the display on the luminances. But many more tone mapping units can be implemented here (whether indeed actually as successive computations in the same or different mapping hardware, or just a single concatenated mapping once), e.g. the grader may implement a fine-tuning, which encodes his taste when we move e.g. the Y″u″v″ image which was graded on e.g. a 3000 nit reference display, to an actual e.g. 250 nit display. This function may then e.g. accentuate the contrast in some important subregion of the luma axis (which we can assume to be [0.1]), i.e. there is a strong slope around say e.g. 0.2. We can also add e.g. a gamma for approximating the effect needed for different surround viewing environments. All kinds of further tunings of the lumas can be done, e.g. to compensate for a TDR-type encoding which we disclosed in hereby incorporated non-prepublished PCT/IB2014/058848), etc., ultimately arriving at the desired Y′ lumas, for deriving the final colors to be rendered, either in a device independent representation like e.g. RGB or XYZ, or already an optimal device-dependent one like R′G′B′ for driving a particular display.

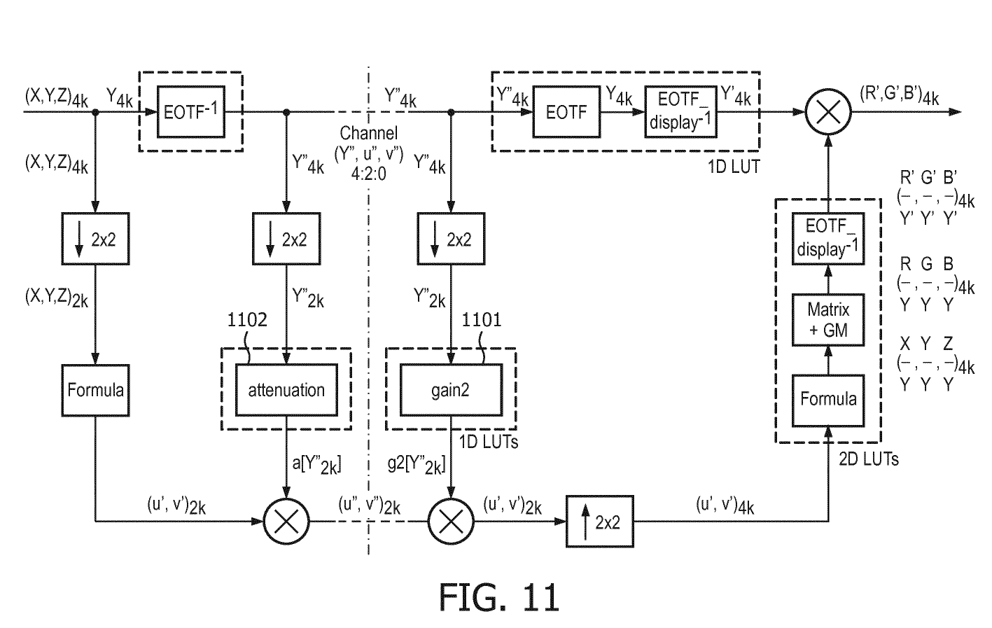

FIG. 11 shows another embodiment, which is a little less accurate in the HDR image reconstruction quality, but cheaper hardware-wsie. We have here similar components like in FIG. 9, with again the upsampling on an u,v, but now on the recovered u′v′ coordinates. The Crayon tip is attenuated and boosted here with the HDR-EOTF determined lumas Y″, and there is no change for chromaticities with Y″>E″. So the gain2 function of gain determiner 1101, is simply the inverse shape (1/attenuation) of the function used by transmitter attenuation determining unit 1102.

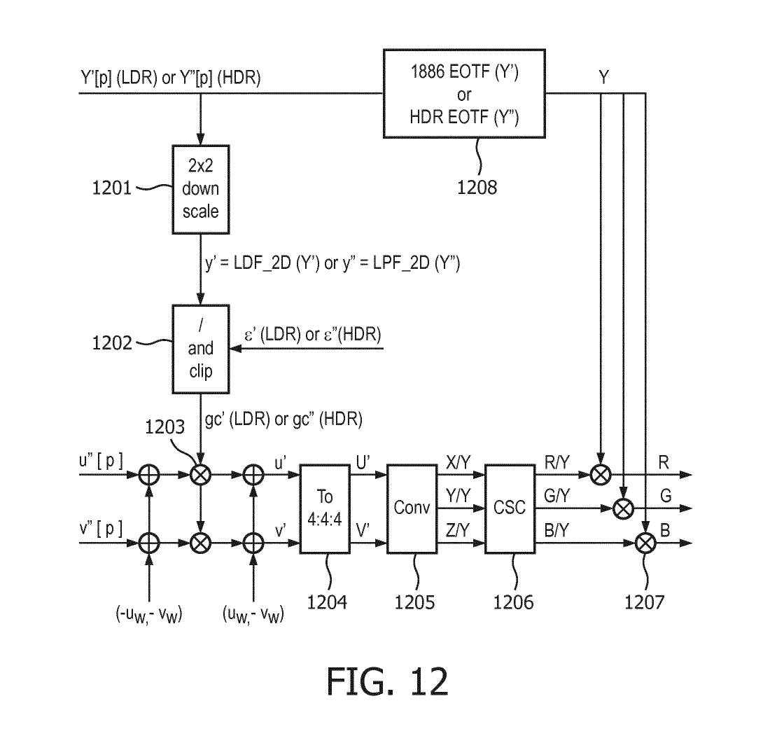

FIG. 12 is another decoder embodiment which again implements similar teachings, but now it outputs linear RGB coordinates, and so the luma-scaled color plane embodiments are now luminance-scaled species embodiments, with color mapper 1205, and color mapper 1206. Upscaler 1204 works on u′v′ like in FIG. 11. Gain determining unit 1202 works similar as in FIG. 9, which the clipped linear gain, or a soft-clipping variant. However, here we have shown that epsilon E″ may vary on whether the decoder is processing an LDR or HDR image (or even something in between potentially). So the Y″u″v″ values inputted are just values within the normal range of YCrCb MPEG values for both cases, but what is actually in the pixel colors (which will show as e.g. a much darker image of a dark basement when an HDR image encoding thereof, i.e. which a significant percentage of the histogram below e.g. luminance 1% or luma e.g. 1200) is different. And the decoder knows whether he is processing an LDR or HDR image. In this example a different value of E″ (in FIG. 12 denoted as □(LDR) vs. □(HDR)), is inputted to a decoder (e.g. from metadata in S_im), which can use it to parametrically reconstruct the needed gain function shape. The same is shown in tone mapper 1208, which can use a different function for the HDR scenario vs. the LDR scenario. Because of course, if we need to drive e.g. an 800 nit display, the processing to obtain the optimal look will be different whether we get a dark HDR version of say a dark basement scene (in which case the tone mapping must brighten up the darker regions of the images a little, because the 800 nit monitor is less bright than e.g. a 5000 nit reference one for which the HDR graded image is optimal), versus when the decoder got an 100 nit-referenced LDR input Y″u″v″ image, which was already brightened (in which case maybe a darkening of the darks is needed to make them more realistically dark on the 800 nit display, and lamps in the scene being then relatively brighter hence more popping). Downsampler 1201 and multiplicative scaler 1203 can here be the same as already described.

The algorithmic components disclosed in this text may (entirely or in part) be realized in practice as hardware (e.g. parts of an application specific IC) or as software running on a special digital signal processor, or a generic processor, etc.

It should be understandable to the skilled person from our presentation which components may be optional improvements and can be realized in combination with other components, and how (optional) steps of methods correspond to respective means of apparatuses, and vice versa. The word “apparatus” in this application is used in its broadest sense, namely a group of means allowing the realization of a particular objective, and can hence e.g. be (a small circuit part of) an IC, or a dedicated appliance (such as an appliance with a display), or part of a networked system, etc. “Arrangement” is also intended to be used in the broadest sense, so it may comprise inter alia a single apparatus, a part of an apparatus, a collection of (parts of) cooperating apparatuses, etc.

The computer program product denotation should be understood to encompass any physical realization of a collection of commands enabling a generic or special purpose processor, after a series of loading steps (which may include intermediate conversion steps, such as translation to an intermediate language, and a final processor language) to enter the commands into the processor, and to execute any of the characteristic functions of an invention. In particular, the computer program product may be realized as data on a carrier such as e.g. a disk or tape, data present in a memory, data traveling via a network connection-wired or wireless- , or program code on paper. Apart from program code, characteristic data required for the program may also be embodied as a computer program product.

Some of the steps required for the operation of the method may be already present in the functionality of the processor instead of described in the computer program product, such as data input and output steps.

It should be noted that the above-mentioned embodiments illustrate rather than limit the invention. Where the skilled person can easily realize a mapping of the presented examples to other regions of the claims, we have for conciseness not mentioned all these options in-depth. Apart from combinations of elements of the invention as combined in the claims, other combinations of the elements are possible. Any combination of elements can be realized in a single dedicated element.

Any reference sign between parentheses in the claim is not intended for limiting the claim.

1. A video decoder having an input for receiving a high dynamic range video signal (S_im) of images transmitted over a video transmission system or received on a video storage product, in which pixel colors are encoded with an achromatic luma coordinate and two chromaticity coordinates, the video decoder comprising in processing order: first a spatial upsampling unit arranged to increase the resolution of the image components with the chromaticity coordinates, secondly a color transformation unit arranged to transform for the pixels of the increased resolution chromaticity component images the chromaticity coordinates into three luminance-independent red, green and blue color components, which are defined so that the maximum possible luma of such a color is 1.0, and thirdly a luminance scaling unit arranged to transform the three luminance-independent red, green and blue color components into a luminance-dependent red, green and blue color representation, by scaling with a common luma factor calculated on the basis of the achromatic luma coordinate.

2. A video decoder as claimed in claim 1, in which the chromaticity coordinates of the input images are defined to have for pixels having lumas below a threshold luma a maximum saturation which is monotonically decreasing with the amount the pixel luma is below the threshold luma.

3. A video decoder as claimed in claim 2, in which in processing order comprises first a downscaler arranged to spatially subsample the input component image of lumas with a subsampling factor, then a gain determiner arranged to determine based on the lumas per pixel in this subsampled image a first gain, then a multiplicative scaler arranged to multiply the chromaticity coordinates with the first gain to yield intermediate chromaticities, in a parallel processing branch comprises an upscaler arranged to upscale again the subsampled image of lumas with the same subsampling factor, and a second gain determiner arranged to calculate a second in on the basis of the lumas of the re-upsampled luma image, then the primary processing branch further comprising an upsampler arranged to upsample the intermediate chromaticities to the resolution of the input component image of lumas, then a second gain multiplier arranged to multiply the chromaticities of the upscaled chromaticity component images with the second gain.

4. A video decoder as claimed in claim 3 in which the intermediate chromaticities are defined from CIE 1976 u′,v′ coordinates, by attenuating the u′v′ coordinates with an attenuation function if the color has a luma Y′ lower than a threshold E″, and boosting the u′v′ coordinates with a boosting function if the color has a luma Y″ higher than a threshold E″.

5. A method of high dynamic range video decoding, comprising:
receiving a video signal (Sim) of images transmitted over a video transmission system or received on a video storage product, in which pixel colors are encoded with an achromatic luma coordinate and two chromaticity coordinates, the method further comprising in processing order: spatial upsampling to increase the resolution of the image components with the chromaticity coordinates, secondly transform for the pixels of the increased resolution chromaticity component images the chromaticity coordinates into three luminance-independent red, green and blue color components, which are defined so that the maximum possible luma of such a color is 1.0, and thirdly transform the three luminance-independent red, green and blue color components into a luminance-dependent red, green and blue color representation, by scaling with a common luma factor calculated on the basis of the achromatic luma coordinate.

6. A method of video decoding as claimed in claim 5, comprising receiving the two chromaticity coordinates in a format which is defined to have for pixels having lumas below a threshold a maximum saturation which is monotonically decreasing with the amount the pixel luma is below the threshold luma, and converting these chromaticity coordinates to standard CIE 1976 uv chromaticities prior to performing the spatial upsampling.

7. A computer program product comprising code which, when executed on a processor performs all method steps of claim 5.
